(19) United States
(12) Patent Application Publication
(10) Pub. No.: US 2024/0075447 A1
(43) Pub. Date: Mar. 7, 2024

(54) CHEMICAL TRANSFORMATION SYSTEM

(71) Applicant: RECARBON, INC., Santa Clara, CA (US)

(72) Inventors: Hatem Harraz, Berkeley, CA (US); Jae Mo Koo, Palo Alto, CA (US); Hee Seon Kim, San Jose, CA (US)

(73) Assignee: RECARBON, INC., Santa Clara, CA (US)

(21) Appl. No.: 18/463,222

(22) Filed: Sep. 7, 2023

Related U.S. Application Data
(60) Provisional application No. 63/374,903, filed on Sep. 7, 2022.

(51) Int. Cl. B01J 19/08; B01J 19/00; B01J 19/24; C01B 3/34

(52) U.S. Cl. CPC B01J 19/088; B01J 19/0013; B01J 19/245; C01B 3/342; B01J 2219/0004; B01J 2219/00117; B01J 2219/00132

(57) ABSTRACT

A device may include a plasma chamber in fluid communication with an ancillary reaction chamber and an integrated reformer. The integrated reformer may be in fluid communication with the ancillary reaction chamber. The ancillary reaction chamber may be configured to utilize heat from a heated first synthesis gas stream received from the plasma chamber to initiate an exothermic reaction with a second gas stream to output a heated second synthesis gas stream to the integrated reformer.

### CROSS REFERENCE TO RELATED APPLICATIONS

This U.S. patent application claims priority to Provisional Patent Application 63/374,903 filed on Sep. 7, 2022. The disclosure of this prior application is considered part of the disclosure of this application and is hereby incorporated by reference in its entirety.

### TECHNICAL FIELD

The present disclosure generally relates to a plasma reaction system with a plasma chamber with one or more additional chambers including any combination of ancillary reaction chambers and integrated reformers.

### BACKGROUND

Unless otherwise indicated herein, the materials described herein are not prior art to the claims in the present application and are not admitted to be prior art by inclusion in this section.

Plasma-based dissociation reactions may be used to facilitate carbon-based chemical reactions. The plasma-based dissociation reactions may provide high temperature and energy to drive completion of the carbon-based chemical reactions.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

A system may include a plasma chamber, an ancillary reaction chamber, and an integrated reformer. The plasma chamber may be configured to: receive a first gas stream from a plasma chamber inlet; apply heat to the first gas stream to form a heated first synthesis gas stream; and output the heated first synthesis gas stream to an ancillary reaction chamber. The ancillary reaction chamber may be configured to receive the heated first synthesis gas stream from the plasma chamber; receive a second gas stream from an ancillary reaction chamber inlet; and output a heated second synthesis gas stream to an integrated reformer. The heated second synthesis gas stream may include a reaction product of the heated first synthesis gas stream and the second gas stream. The integrated reformer may be configured to receive the heated second synthesis gas stream from a first integrated reformer inlet; receive a third gas stream from a second integrated reformer inlet; and output syngas from the integrated reformer.

A device may include a plasma chamber in fluid communication with an ancillary reaction chamber; and an integrated reformer in fluid communication with the ancillary reaction chamber. The ancillary reaction chamber may be configured to use heat from a heated first synthesis gas stream received from the plasma chamber to initiate an exothermic reaction with a second gas stream to output a heated second synthesis gas stream to the integrated reformer.

A method for plasma carbon conversion may include: sending, from a plasma chamber to an ancillary reaction chamber, a heated first synthesis gas stream; mixing, at the ancillary reaction chamber, the heated first synthesis gas stream with a second gas stream to initiate an exothermic reaction between the heated first synthesis gas stream and the second gas stream; generating, at the ancillary reaction chamber, second thermal energy using the exothermic reaction; sending, from the ancillary reaction chamber to an integrated reformer, the second thermal energy to the integrated reformer; and generating, at the integrated reformer, syngas using the second thermal energy.

### BRIEF DESCRIPTION OF THE DRAWINGS

Example embodiments will be described and explained with additional specificity and detail through the accompanying drawings in which:

FIG. 1 illustrates a block diagram of a plasma carbon conversion unit according to an example.

FIG. 2 illustrates operation of a plasma reaction system according to an example.

FIG. 3 illustrates operation of a plasma chamber, an ancillary reaction chamber, and an integrated reformer according to an example.

FIG. 4 illustrates a block diagram of a plasma reaction system including a plasma chamber, an ancillary reaction chamber, and an integrated reformer according to an example.

FIG. 5 illustrates a block diagram of a plasma reaction system including a plasma chamber, an ancillary reaction chamber, and an integrated reformer according to an example.

FIG. 6 illustrate block flow diagram of a plasma reaction system including a plasma chamber, an ancillary reaction chamber, and an integrated reformer according to an example.

FIG. 7A illustrates a block diagram of a plasma reaction system including a plasma reaction chamber and an ancillary reaction chamber connected in parallel to a plurality of integrated reformers according to an example.

FIG. 7B illustrates a block diagram of a plasma reaction system including a plurality of plasma reaction chambers connected in series to a plurality of ancillary reaction chambers, which are connected to an integrated reformer according to an example.

FIG. 7C illustrates a block diagram of a plasma reaction system including a plurality of plasma reaction chambers connected in series to a plurality of ancillary reaction chambers, which are connected to an integrated reformer according to an example.

FIG. 7D illustrates a block diagram of a plasma reaction system including a plurality of plasma reaction chambers connected to an ancillary reaction chamber which is connected to an integrated reformer according to an example.

FIG. 7E illustrates a block diagram of a plasma reaction including a plurality of plasma reaction chambers connected to an ancillary reaction chamber which is connected to an integrated reformer, which is connected to a plurality of ancillary reaction chambers, according to an example.

FIG. 7F illustrates a block diagram of a plasma reaction system including a plurality of plasma reaction chambers connected to an ancillary reaction chamber which is connected to an integrated reformer, which is connected to a plurality of ancillary reaction chambers at different inlets, according to an example.

FIG. 8 illustrates a diagram of a system for carbon dioxide utilization using a plasma reaction system according to an example.

FIG. 9 illustrates a diagram of a system for synthesizing hydrogen gas and carbon monoxide using a plasma reaction system according to at an example.

FIG. 10 illustrates a diagram of a system for converting biogas into hydrogen gas using a plasma reaction system according to an example.

FIG. 11 illustrates an integrated reformer according to an example.

FIG. 12 illustrates a process flow for a plasma reaction system according to an example.

Like reference symbols in the various drawings indicate like elements.

### DETAILED DESCRIPTION

Gas reactions may be affected within a reactor chamber of a gas reactor configured for inlet and outlet flow of gases. The inlet flow of gases may include one or more gas reactants, and the outlet flow may include one or more gas products generated based on the gas reactants included in the inlet flow. In some situations, gas reactions may be exothermic reactions that produce heat during the reaction process, while in other situations, the gas reactions may be endothermic reactions that use heat input to drive the reaction process. As such, the reactor chamber in which the gas reactions occur may reach high temperatures during operation of the gas reactor.

A syngas product may be generated with an H₂:CO ratio (syngas ratio) of from about 0.5:1 to 3:1. Generating the syngas product may use various heat input during different stages of the reaction process. Maximizing the use of the generated thermal energy, recycling different gas streams, and maintaining the materials used in the high temperature reaction process may facilitate an increase in the syngas production capacity, the H₂:CO ratio, and the energy conversion efficiency.

A plasma reaction system may allow for processing or reformation (i.e., rearrangement of a molecular structure of hydrocarbons included in a gas) of gas by injecting unreacted gas after a plasma chamber included in the plasma reaction system. The unreacted gas injected after the plasma chamber may react with “waste” residual energy contained in the processed stream from the plasma chamber. This is accomplished with one or more inlets designed to introduce the additional gas stream into the post-plasma chamber stream and effect mixing between the two gas streams. In cases where the reformation of the post-plasma stream is exothermic, the temperature of the mixed stream may be high enough for reformation to occur.

After mixing, an ancillary reaction chamber may provide sufficient residence time for reformation to occur in the mixed-gas stream. Additionally or alternatively, the ancillary reaction chamber may be or externally cooled. The gas stream may leave the ancillary reaction chamber and flow into piping or tubing for further processing or storage of the gases.

Also after the ancillary reaction chamber, an integrated reformer may also be present. The integrated reformer may be a discrete reaction unit that may connected to the plasma reactor and/or to the ancillary reaction chamber. For systems that include a plasma reactor, an ancillary reaction chamber, and an integrated reformer, each of these units may be individual units, or may be combined in a plasma reactor-ancillary reaction chamber-integrated reformer combined unit, where the ancillary reaction chamber and the integrated reformer may be coupled to the plasma reactor, and to each other, in any order, combination, including in series, parallel, or a combination thereof. An ancillary reaction chamber may provide a plasma reaction and the integrated reformer may facilitate a non-plasma reaction.

A plasma chamber may be configured to facilitate the transfer of high thermal energy from the plasma chamber to an ancillary reaction chamber. The high thermal energy may be used by an ancillary reaction chamber to initiate a reforming reaction without using an external heat input for the ancillary reaction chamber. The reaction in the ancillary reaction chamber may be an exothermic reaction that may direct output gas at a high temperature (high thermal energy) to an integrated reformer. The reforming reaction, in the integrated reformer, may use the high thermal energy in the product gas from the ancillary reaction chamber without using an external heat input. The reaction in the integrated reformer may be an endothermic reaction. Heat transferred from the plasma chamber and the ancillary reaction chamber may be used to initiate the endothermic reaction in the integrated reformer. The remaining heat in the product gas from the integrated reformer may be used to preheat the feed gases (e.g., to the plasma chamber, to the ancillary reaction chamber, or to the back into the integrated reformer).

The plasma chamber, the ancillary reaction chamber, and the integrated reformed may facilitate the chemical reactions: (i) at the plasma chamber, natural gas (NG) reforming with CO₂ and/or O₂, (ii) at the ancillary reaction chamber, NG reforming with CO₂ and/or O₂, and (iii) at the integrated reformer, NG reforming with H₂O. That is, the net chemical reactions in one or more of the plasma chamber, the ancillary reaction chamber, and the integrated reformer may include: (i) R0: a₀CO₂+b₀CH₄+c₀O₂→d₀H₂+f₀CO+minor species (i.e., for the plasma chamber), (ii) R1: a₁CO₂+b₁CH₄+c₁O₂→d₁H₂+f₁CO+minor species (i.e., for the ancillary reaction chamber), and (iii) R2: a₂H₂O+b₂CH₄→d₂H₂+f₂CO+minor species (i.e., for the integrated reformer).

Using an ancillary reaction chamber with a plasma chamber and an integrated reformer may facilitate an amplification of syngas production of up to 70× in volume compared to syngas production that does not use the ancillary reaction chamber. The feed capacities may also be increased (e.g., the CO₂ and CH₄ feed capacities may be 30× and 50× amplified compared to feed capacity that does not use the ancillary reaction chamber). Syngas may be generated in the plasma chamber and in the ancillary reaction chamber at ratios of about H2:CO=0.5:1˜1:1. Syngas may be generated in the integrated reformer at a ratio of about H2:CO=2:1˜3:1. As a result, the final syngas ratio (the ratio of syngas generated from the integrated reformer compared to the syngas received at the input to the plasma chamber) may have a ratio of H₂:CO=1.2:1˜2:1.

Using an ancillary reaction chamber positioned between a plasma chamber and an integrated reformer may facilitate: (i) increased energy efficiency because the high thermal energy of the product gas from the plasma reactor may be used for the further reforming reactions without any additional power input, (ii) reduced steam feed for reforming when the steam generated from the plasma reactor is used, and (iii) an increased syngas production capacity (e.g., syngas product up to 70 times with H₂:CO=2:1).

Reference will now be made to the drawings to describe various aspects of examples. It is to be understood that the drawings are diagrammatic and schematic representations of such example embodiments, and are not limiting of the present disclosure, nor are they necessarily drawn to scale.

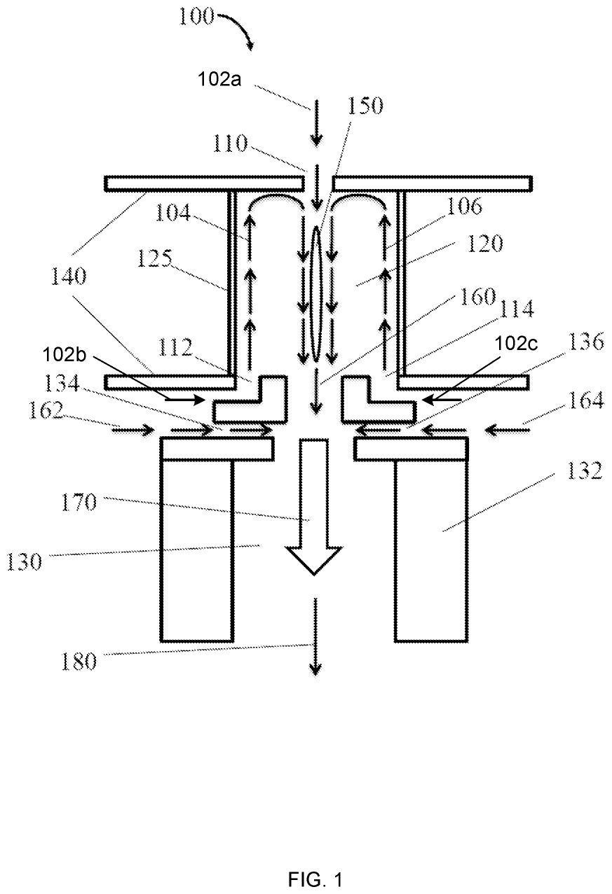

FIG. 1 illustrates a cross-sectional view of a plasma reaction system 100 that includes a plasma chamber 120 and an ancillary reaction chamber 130. The plasma chamber 120 may include any number of inlets, including a first inlet 110, a second inlet 112, and a third inlet 114 through which one or more gases 102a, 102b, 102c may flow to enter the plasma chamber 120. Two or more of the first inlet 110, the second inlet 112, or the third inlet may be positioned on opposite or substantially opposite sides of the plasma chamber 120 such that a gas flow 102a corresponding to the first inlet 110 and a gas flow 102b corresponding to the second inlet 112 may generate forward and reverse vortex arrangements within the plasma chamber 120 that facilitate mixing and reaction of the gases 102a and 102b within the plasma chamber 120. The first inlet 110 and/or the second inlet 112 and/or the third inlet 114 may be positioned along any surface or other part of the plasma chamber 120 and oriented in any direction to facilitate the flow of the gases 102a, 102b, 102c into the plasma chamber 120 with different vortex arrangements between the first inlet 110 and/or the second inlet 112 and/or the third inlet 114. For example, the first inlet 110 may be positioned on a top surface of the plasma chamber 120 such that the gases 102a enter from the top of the plasma chamber 120, while the second inlet 112 and/or the third inlet 114 may be positioned on a bottom surface of the plasma chamber 120 such that the gases 102b, 102c enter from the bottom of the plasma chamber 120. As another example, the second inlet 112 and the third inlet 114 may both be along a lateral surface of the plasma chamber 120 with the second inlet 112 and the third inlet 114 being positioned opposite or substantially opposite with respect to each other. In some embodiments, the plasma chamber 120 may include one or more of the first inlet 110, or the second inlet 112, or the third inlet 114.

More than one inlet may be oriented in a particular direction such that the forward vortex arrangement (i.e., corresponding to the first inlet 110) and/or the reverse vortex arrangement (i.e., corresponding to the second inlet 112) may include a plurality of inlet ports. As illustrated in FIG. 1, for example, the reverse vortex arrangement may be formed by the gases 102b and 102c flowing through the second inlet 112 and/or a third inlet 114 that may be oriented in the same or a similar flow direction as the second inlet 112. Additionally or alternatively, the forward vortex arrangement may include more inlet ports than the first inlet 110, such as one or more inlet ports adjacent to the first inlet 110. The gases 102a, 102b, 102c entering the plasma chamber 120 via the plurality of inlet ports, which may contribute to the forward and/or the reverse vortex arrangements, may or may not mix together to form a single gas stream moving in the same direction. The gases 102b and 102c flowing through the second inlet 112 and the third inlet 114 may form gas flow streams 104 and 106, respectively, in which the gas flow streams 104, 106 enter the plasma chamber 120 as discrete streams that mix within the plasma chamber 120 after being redirected by the top surface of the plasma chamber 120.

One or more chamber walls 125 may enclose the plasma chamber 120 and demarcate an interior space of the plasma chamber 120 in which chemical reactions between gases flowing into the plasma chamber 120 may occur. The chamber walls 125 may be one or more of: opaque to gases, inert with respect to chemical reactions that occur within the plasma chamber 120, have a high melting temperature, or include a low coefficient of thermal expansion. For example, the chamber walls 125 may be include one or more of quartz, boron nitride, aluminum, ceramics, silicon carbide, tungsten, molybdenum, any other refractory materials, or a mixture thereof. Additionally or alternatively, the chamber walls 125 may be made of a radiofrequency-transparent material that allows energy directed by one or more waveguides 140 to feed a plasma 150 inside the plasma chamber 120. As such, energy from a microwave, electricity, or other source may be directed through the chamber walls 125 by the waveguides 140 to supply energy for the plasma 150 and the plasma chamber 120.

In these and other embodiments, an average temperature of the plasma chamber 120 may generally range from approximately 1,000 Kelvin (K) to approximately 3,500 K, while a peak temperature of the plasma 150 may reach approximately 50,000 K or higher. The temperature at particular locations within the plasma chamber 120 (e.g., in the center of the plasma chamber 120) may exceed the melting point of the chamber walls 125 and/or the waveguides 140 in some instances. Because the forward vortex arrangement and/or the reverse vortex arrangement of the gases 102a, 102b, 102c may provide an insulating effect, the chamber walls 125 and/or the waveguides 140 may not reach their respective melting points when the temperature at particular locations of the plasma chamber 120 exceeds those melting points.

The gases 102a, 102b, 102c in the plasma chamber 120 may include reactant gases involved in chemical reactions relating to natural gas reformation, hydrocarbon generation, reactant combustion, or any other chemical reactions that may be facilitated in a high-temperature reaction environment provided by the plasma chamber 120 in which heat from the plasma 150 may provide sufficient energy to break molecular bonds and/or initiate particular chemical reactions. An outlet gas stream 160 may include chemical products formed by the chemical reactions that occur in the plasma chamber 120 and unreacted reactants included in the gases 102a, 102b, 102c that entered the plasma chamber 120.

The outlet gas stream 160 may be mixed with one or more ancillary reaction chamber gas flows 162, 164 to form an ancillary reaction chamber inlet flow 170. The ancillary reaction chamber gas flows 162, 164 may include the same or similar gases as the gases 102a, 102b, 102c injected into the plasma chamber 120. Additionally or alternatively, the ancillary reaction chamber gas flows 162, 164 may include reactants that were not present in the gases 102a, 102b, 102c and/or materials that facilitate the occurrence of one or more chemical reactions in the ancillary reaction chamber 130. For example, waste gases and/or liquids from related chemical processes or other plasma reactors may be included in the ancillary reaction chamber gas flows 162, 164 to increase a waste-to-product reformation ratio of one or more of the waste gases or liquids. Further, waste-to-energy reformation may be increased relative to a threshold by including waste in the ancillary reaction chamber gas flows 162, 164.

Oxidizer gases, such as air, oxygen, nitric oxide, etc., may be included in the ancillary reaction chamber gas flows 162, 164 to drive particular chemical reactions and facilitate generation of particular chemical products. By including an ancillary reaction chamber 130 that obtains the outlet gas stream 160 and various other gases, a degree of reaction of one or more chemical reactants may be increased to increase the efficiency of the plasma reaction system 100. Additionally or alternatively, including the ancillary reaction chamber 130 in the plasma reaction system 100 may allow for a smaller plasma chamber 120 because the ancillary reaction chamber 130 may increase a conversion rate of chemical reactants. In these and other embodiments, the ancillary reaction chamber gas flows 162, 164 may include a total flowrate ranging from approximately 50% up to approximately 5000% of the flowrate of the outlet gas stream 160 exiting the plasma chamber 120 to provide gases and/or liquids for chemical reactions to take place in the ancillary reaction chamber 130.

The ancillary reaction chamber gas flows 162, 164 may be directed via one or more ancillary reaction chamber inlets 134, 136 to mix with the outlet gas stream 160 of the plasma chamber 120. In some embodiments, the ancillary reaction chamber inlets 134, 136 may be oriented at approximately 90° relative to the outlet gas stream 160 such that the ancillary reaction chamber gas flows 162, 164 may be approximately perpendicular to the outlet gas stream 160. Additionally or alternatively, the ancillary reaction chamber inlets 134, 136 may be oriented at approximately at an angle ranging from approximately 30° to approximately 180° (i.e., countercurrent) relative to the outlet gas stream 160. Additionally or alternatively, a number of ancillary reaction chamber inlets and/or an orientation of each ancillary reaction chamber inlet may differ from the two ancillary reaction chamber inlets 134, 136 and the two ancillary reaction chamber gas flows 162, 164 aimed at the same or similar orientations relative to the outlet gas stream 160. For example, a single ancillary reaction chamber inlet aimed at 180° relative to the outlet gas stream 160 may be used. As another example, three ancillary reaction chamber inlets aimed at varying angles relative to the outlet gas stream 160 may be used. A size and/or a number of ancillary reaction chamber inlets (e.g., two ancillary reaction chamber inlets 136, 136) may be set based on a selected flowrate through the plasma chamber 120 and/or the ancillary reaction chamber 130.

The ancillary reaction chamber inlet flow 170 may be directed towards the ancillary reaction chamber 130 for further processing of one or more of the gases included in the ancillary reaction chamber inlet flow 170. One or more walls 132 of the ancillary reaction chamber 130 may be made of a material that has a high thermal resistance and/or a low coefficient of thermal expansion. For example, the walls 132 may include one or more of carbon steel or other carbon composites, a nickel alloy, aerospace-grade aluminum, titanium, quartz, ceramics, tungsten, molybdenum, or any other suitable material, including any refractory materials.

The gases included in the ancillary reaction chamber inlet flow 170 may react in the ancillary reaction chamber 130 to yield one or more chemical products. The chemical products yielded by the chemical reactions in the ancillary reaction chamber 130 may include the same chemical products yielded by chemical reactions that occurred in the plasma chamber 120. Additionally or alternatively, the chemical products formed in the ancillary reaction chamber 130 may include various chemicals that are not formed in the plasma chamber 120 based on different chemical reactions facilitated by materials included in the ancillary reaction chamber gas flows 162, 164 that were not present in the gases 102a, 102b, 102c that entered the plasma chamber 120.

In these and other embodiments, the chemical reactions occurring in the ancillary reaction chamber 130 may be facilitated by heat carried over from the plasma chamber 120. As such, the ancillary reaction chamber 130 may not include any plasma, and energy sources for heating the plasma 150 may not be directed towards the ancillary reaction chamber 130. The absence of plasma and/or directed energy sources may cause the ancillary reaction chamber 130 to operate at lower temperatures than the plasma chamber 120, and the ancillary reaction chamber 130 may include a larger volume and/or operate at a same or different pressure (e.g., higher or lower) than the plasma chamber 120 to facilitate the occurrence of the chemical reactions. Additionally or alternatively, the ancillary reaction chamber 130 may be made of a less heat-resistant material than the plasma chamber 120 because the ancillary reaction chamber 130 may operate at lower temperatures than the plasma chamber 120. For example, the plasma chamber 120 may include an aerospace grade aluminum, while the ancillary reaction chamber 130 may include a molybdenum metal.

The chemical products formed during chemical reactions occurring in the ancillary reaction chamber 130, any unreacted chemical reactants, and any other gases included in the ancillary reaction chamber 130 may be directed out of the ancillary reaction chamber 130 in an outlet gas flow 180. The outlet gas flow 180 may be sent to an ancillary equipment of the plasma reaction system 100, such as a scrubber, a pressure-swing adsorption unit, an amine unit, and/or a compressor. Additionally or alternatively, the outlet gas flow 180 may be sent to a second-stage ancillary reaction chamber for further processing of the products, unreacted chemicals, and/or any other gases included in the outlet gas flow 180. Additionally or alternatively, the outlet gas flow 180 may be sent to an integrated reformer for further processing of the products, unreacted chemicals, and/or any other gases included in the outlet gas flow 180.

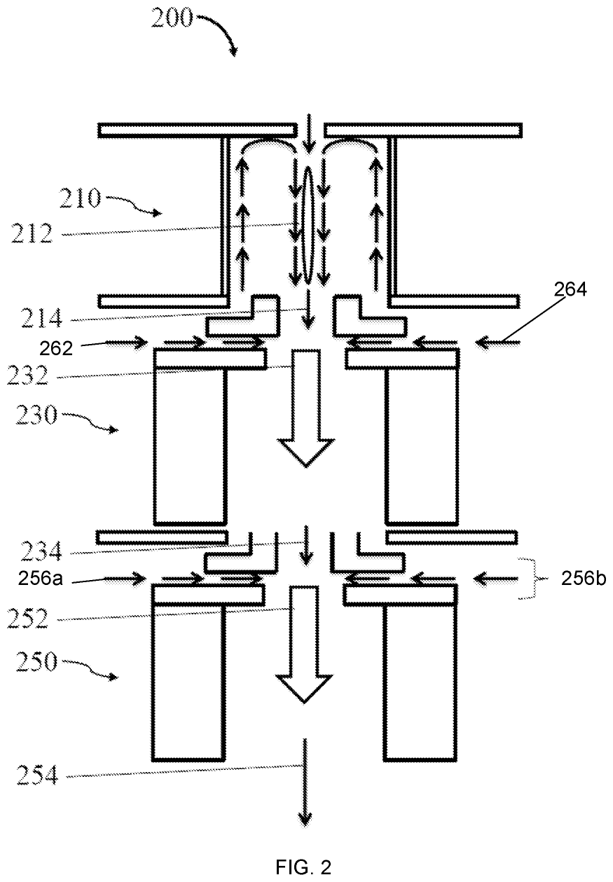

As illustrated in FIG. 2, a plasma reaction system 200 may include: (i) a plasma chamber 210 in fluid communication with (ii) an ancillary reaction chamber 230; and (iii) an integrated reformer 250 in fluid communication with the ancillary reaction chamber. The ancillary reaction chamber 230 may be configured to absorb heat from a heated first synthesis gas stream 214 received from the plasma chamber to initiate an exothermic reaction with one or more second gas streams 262, 264 to output a heated second synthesis gas stream 234 to the integrated reformer 250. The “heated second synthesis gas stream” may be the reaction product of the reaction between the heated first synthesis gas stream and the second gas stream.

The plasma reaction system 200 may include a plasma chamber 210 connected with one or more ancillary reaction chambers (e.g., ancillary reaction chamber 230), and one or more integrated reformers (e.g., integrated reformer 250) in series. The plasma chamber 210 may be the same as or similar to the plasma chamber 120 as described in relation to FIG. 1. As such, the plasma chamber 210 may be configured to obtain one or more inlet flows in which each inlet flow may include one or more gases and/or a particular vortex arrangement. Additionally or alternatively, the plasma chamber 210 may include a plasma that is heated by an energy source, such as a microwave source or an electricity source. In these and other embodiments, the first ancillary reaction chamber 230 may be the same as or similar to the ancillary reaction chamber 130 as described in relation to FIG. 1. As such, the ancillary reaction chamber 230 may have a size or volume greater than a size or volume of the plasma chamber 210 and/or may operate at a pressure the same as or different than a pressure of the plasma chamber 210.

The integrated reformer 250 may be connected to the ancillary reaction chamber 230 by having an outlet flow of a heated second synthesis gas stream 234 of the first ancillary reaction chamber 230 mixed with one or more third gas stream 256a, 256b (e.g., an input flow into the integrated reformer 250) and feed into the integrated reformer 250 as an integrated reformer inlet flow 252.

The integrated reformer 250 may not be connected to a heat source, such as a plasma 212 used to heat the plasma chamber 210. The integrated reformer may use heat from a heated second synthesis gas stream 234 to initiate an endothermic reaction to generate outlet flow 254 (e.g., gas product, such as syngas). As such, chemical reactions that may occur in the integrated reformer 250 between gases included in the integrated reformer flow 252 may be facilitated by heat from the ancillary reaction chamber 230, which may be received by the integrated reformer 250 along with the gases in the outlet flow of a heated second synthesis gas stream 234 of the ancillary reaction chamber 230.

A temperature of the integrated reformer 250 may be less than the temperature of the ancillary reaction chamber 230. As such, the integrated reformer 250 may be made of a material that is less heat resistive and/or include a greater coefficient of thermal expansion than a material used for the ancillary reaction chamber 230 and/or the plasma chamber 210. Additionally or alternatively, the integrated reformer 250 may include a greater volume and/or operate at a same or different pressure than the ancillary reaction chamber 230 to facilitate chemical reactions that occur in the integrated reformer 250.

An outlet flow 254 of the integrated reformer 250 may be sent to an ancillary equipment of the plasma reaction system 100, such as a scrubber, a pressure-swing adsorption unit, an amine unit, and/or a compressor, for further processing of the gases included in the outlet flow 254. The outlet flow 254 may be directed towards one or more additional ancillary reaction chambers and/or integrated reformers, such as a second ancillary reaction chamber in series, a second and a third ancillary reaction chamber in series, etc. or any combination. In these and other embodiments, an operating temperature of each subsequent ancillary reaction chamber in the series of ancillary reaction chambers and/or integrated reformers may be less than the operating temperature of the previous chamber in the series. As such, each subsequent chamber may have a greater size and/or volume and/or a same or different pressure than the previous chamber in the series.

The outlet flow 254 of the integrated reformer 250, the outlet flow of a heated second synthesis gas stream 234 of the ancillary reaction chamber 230, and/or an outlet flow of a heated first synthesis gas stream 214 of the plasma chamber 210 may be directed towards one or more chambers (e.g., ancillary reaction chambers, integrated reformers) that may be configured in parallel with respect to one another.

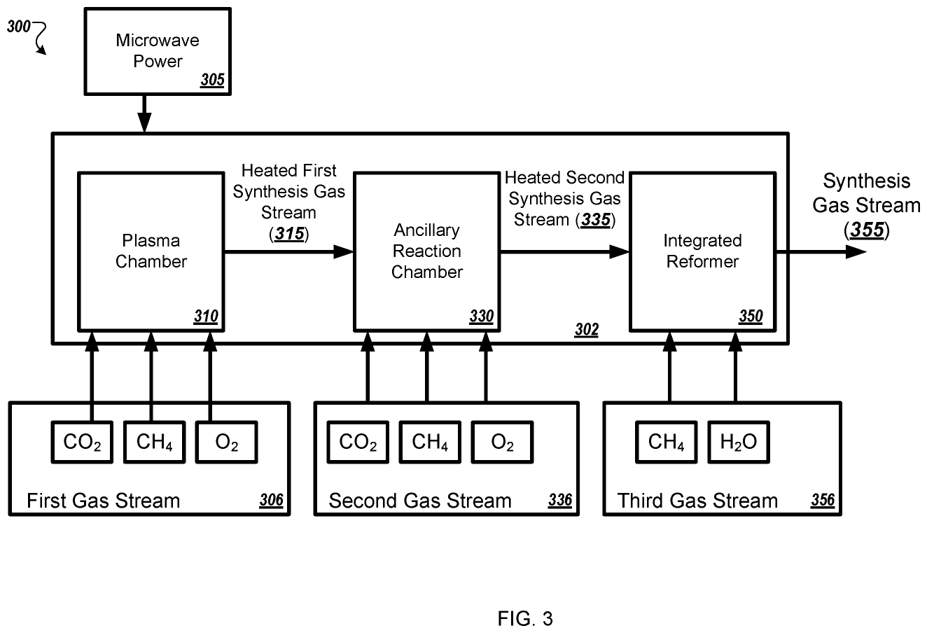

As illustrated in FIG. 3, a plasma reaction system 300 may include a plasma carbon conversion unit 302. The plasma carbon conversion unit 302 may include one or more of a plasma chamber 310, an ancillary reaction chamber 330, or an integrated reformer 350. The plasma chamber 310 may be configured to receive a first gas stream 306, which may include one or more of CO₂, CH₄ (e.g., methane, natural gas, or a renewable natural gas), 02, or the like from one or more plasma chamber inlets.

The first gas stream may be directed into the plasma chamber 310 at a reference input flow rate of 1×. The first gas stream may include any suitable ratio of gases to generate heat. The first gas stream may include a CO₂:CH₄ ratio of from about 1:10 to about 10:1. Alternatively or in addition, the first gas stream may include a CO₂:CH₄ ratio of from about 3:7 to about 5:5. The first gas stream may include a (CO₂+CH₄):O₂ ratio of from about 1:10 to about 10:1. Alternatively or in addition, the first gas stream may include a (CO₂+CH₄):O₂ ratio of from about 3:2 to about 4:1.

The plasma chamber 310 may be configured to apply power to the first gas stream to form a heated first synthesis gas stream 315. The plasma chamber 310 may be configured to apply heat to the first gas stream 306 using an external power source (e.g., microwave power 305). The external power source (e.g., microwave power 305) may be configured to facilitate an exothermic reaction in the plasma chamber 310 to apply heat to the first gas stream 306. Alternatively or in addition, the plasma chamber 310 may be configured to use an endothermic reaction to apply heat to the first gas stream 306. The plasma chamber 310 may be configured to output the heated first synthesis gas stream 315 to an ancillary reaction chamber 330 at a reference output flow rate of about 1× to 2× compared to the reference input flow rate. The heated first synthesis gas stream 315 may be output to the ancillary reaction chamber 330 at a syngas ratio of from about 1:10 to about 10:1. Alternatively or in addition, the heated first synthesis gas stream 315 may be output to the ancillary reaction chamber 330 at a syngas ratio of from about 1:2 to about 1:1. The syngas ratio may be the ratio of volumetric H₂ to CO in syngas (i.e., H₂:CO).

The ancillary reaction chamber 330 may be configured to receive the heated first synthesis gas stream 315 from the plasma chamber 310 at a flow rate (reference output flow rate 1×) that may be substantially the same as or higher than the flow rate provided to the plasma chamber 310 (reference input flow rate 1×). The flow rate between two different flow rates may be substantially the same when the percentage difference between the lower flow rate and the higher flow rate is less than one or more of: 10%, 5%, 3%, 2%, or 1% (i.e., computed as: (1−(lesser rate/higher rate)×100)). The ancillary reaction chamber 330 may be configured to receive a second gas stream 336 (e.g., which may include one or more of CO₂, CH₄, O₂, or the like) from an ancillary reaction chamber inlet at a flow rate that may be from about 1× to about 29× the flow rate of the reference input flow rate (i.e., as provided to the plasma chamber 310 at a flow rate of 1×). The second gas stream 336 may include ratios that may be similar to the ratios provided for the first gas stream 306. That is, the second gas stream 336 may include a CO₂:CH₄ ratio of from about 1:10 to about 10:1. Alternatively or in addition, the second gas stream 336 may include a CO₂:CH₄ ratio of from about 3:7 to about 5:5. The second gas stream 336 may include a (CO₂+CH₄):O₂ ratio of from about 1:10 to about 10:1. Alternatively or in addition, the second gas stream 336 may include a (CO₂+CH₄):O₂ ratio of from about 3:2 to about 4:1.

The ancillary reaction chamber 330 may be configured to use the thermal energy from the heated first synthesis gas stream 315, as received from the plasma chamber 310, to initiate an exothermic reaction. The ancillary reaction chamber 330 may be configured to initiate the exothermic reaction using the thermal energy from the heated first synthesis gas stream 315 without using an additional external heat input.

The ancillary reaction chamber 330 may be configured to output a heated second synthesis gas stream 335 to an integrated reformer 350. The heated second synthesis gas stream 335 may include the reaction product of the heated first synthesis gas stream 315 and the second gas stream 336. The flow rate for the heated second synthesis gas stream 335, as directed from the ancillary reaction chamber 330 to the integrated reformer 350, may be from about 2× to about 30× the reference output flow rate (e.g., as provided from the plasma chamber 310 at a flow rate of 1.0×). The heated second synthesis gas stream 335 may be output to the integrated reformer 350 at a syngas ratio (e.g., H₂:CO) of from about 1:10 to about 10:1. Alternatively or in addition, the heated second synthesis gas stream may be output to the integrated reformer 350 at a syngas ratio of from about 1:2 to about 1:1.

The integrated reformer 350 may be configured to receive the heated second synthesis gas stream 335 from the first integrated reformer inlet and receive a third gas stream 356 (e.g., which may include CH₄, H₂O, or the like) from a second integrated reformer inlet at a flow rate that may be from about 2× to about 20× the flow rate of the reference input flow rate (i.e., as provided to the plasma chamber 310 at a flow rate of 1.0×). The third gas stream 356 may include an H₂O:CH₄ ratio of from about 1:10 to about 10:1. Alternatively or in addition, the third gas stream 356 may include an H₂O:CH₄ ratio of from about 1:2 to about 3:1.

The integrated reformer 350 may be configured to use the thermal energy from the heated second synthesis gas stream 335, as received from the ancillary reaction chamber 330, to initiate an endothermic reaction. The integrated reformer 350 may be configured to initiate the endothermic reaction using the thermal energy from the heated second synthesis gas stream 335 without using an additional external heat input to the integrated reformer. Alternatively or in addition, remaining thermal energy from the heated second synthesis gas stream 335 that may be output from the integrated reformer 350 may be used to preheat various feed gases (e.g., first gas stream 306, second gas stream 336, third gas stream 356, or the like).

The integrated reformer 350 may be configured to output a synthesis gas stream 355 (e.g., syngas) from the integrated reformer 350 at a flow rate of from about 4× to about 70× when compared to the reference output flow rate (i.e., as provided from the plasma chamber 310 at a flow rate of 1.0×).

The synthesis gas stream 355 may be produced from the integrated reformer 350 at a syngas ratio (that may be different from the incoming syngas ratio received at the integrated reformer 350) of from about 1:10 to about 10:1. Alternatively or in addition, the synthesis gas stream 355 may be produced from the integrated reformer 350 at a syngas ratio (that may be different from the incoming syngas ratio received at the integrated reformer 350) of from about 2:1 to about 3:1. Alternatively or in addition, the synthesis gas stream 355 may be output from the integrated reformer 350 at a final syngas ratio (that may be a combination of syngas ratio produced from the integrated reformer 350 and the incoming syngas ratio received at the ancillary reaction chamber 330) of from about 1:10 to about 10:1. Alternatively or in addition, the synthesis gas stream 355 may be output from the integrated reformer 350 at a final syngas ratio (that may be a combination of syngas ratio produced from the integrated reformer 350 and the incoming syngas ratio received at the ancillary reaction chamber 330) of from about 6:5 to about 2:1.

One or more of the plasma chamber 310, the ancillary reaction chamber 330, or the integrated reformer 350 may be configured to perform various chemical reactions such as partial oxidation reactions, dry methane reforming reactions, steam methane reforming reactions, hydrocarbon cracking reactions, water gas shift reactions, methanol synthesis reactions, or the like. A partial oxidation reaction may include, e.g., CH₄+½ O₂→2H₂+CO. A dry methane reforming reaction may include, e.g., CH₄+CO₂→2H₂+2CO. A steam methane reforming reaction may include, e.g., CH₄+H₂O→3H₂+CO. A hydrocarbon cracking reaction may include e.g., CxHy→CH₄+H₂+C+minor species. A water gas shift reaction may include, e.g., CO+H₂O→H₂+CO₂. A methanol synthesis reaction may include, e.g., 2H₂+CO→CH₃OH.

The plasma chamber 310 may be configured to perform any suitable reaction including one or more of a partial oxidation reaction, a dry methane reforming reaction, a steam methane reforming reaction, or a hydrocarbon cracking reaction. In one example, the plasma chamber 310 may be configured to perform one or more of: (i) a partial oxidation reaction+dry methane reforming reaction, (ii) a dry methane reforming reaction, (iii) a steam methane reforming reaction, or (iv) a hydrocarbon cracking reaction. In one example, the plasma chamber 310 may be configured to facilitate the net chemical reaction: R0: a₀CO₂+b₀CH₄+c₀O₂→d₀H₂+f₀CO+minor species.

The ancillary reaction chamber 330 may be configured to perform any suitable exothermic reaction using the thermal energy received from the plasma chamber 310 to initiate the exothermic reaction. The ancillary reaction chamber 330 may be configured to perform one or more of a partial oxidation reaction, a dry methane reforming reaction, or a steam methane reforming reaction. In one example, the ancillary reaction chamber 330 may be configured to perform one or more of: (i) a partial oxidation reaction+dry methane reforming reaction, or (ii) a partial oxidation+steam methane reforming reaction. In one example, the ancillary reaction chamber 330 may be configured to facilitate the net chemical reaction: R1: a₁CO₂+b₁CH₄+c₁O₂→d₁H₂+f₁CO+minor species.

The integrated reformer 350 may be configured to perform any suitable endothermic reaction using the thermal energy received from the ancillary reaction chamber 330 to perform the endothermic reaction. The integrated reformer 350 may be configured to perform one or more of (i) a steam methane reforming reaction, (ii) a dry methane reforming reaction, (iii) a water gas shift reaction, (iv) a catalytic reaction, or (v) a non-catalytic reaction (e.g., to produce methanol, liquid fuel, chemicals, plastics, of the like). In one example, the integrated reformer 350 may be configured to facilitate the net chemical reaction: R2: a₂H₂O+b₂CH₄→d₂H₂+f₂CO+minor species.

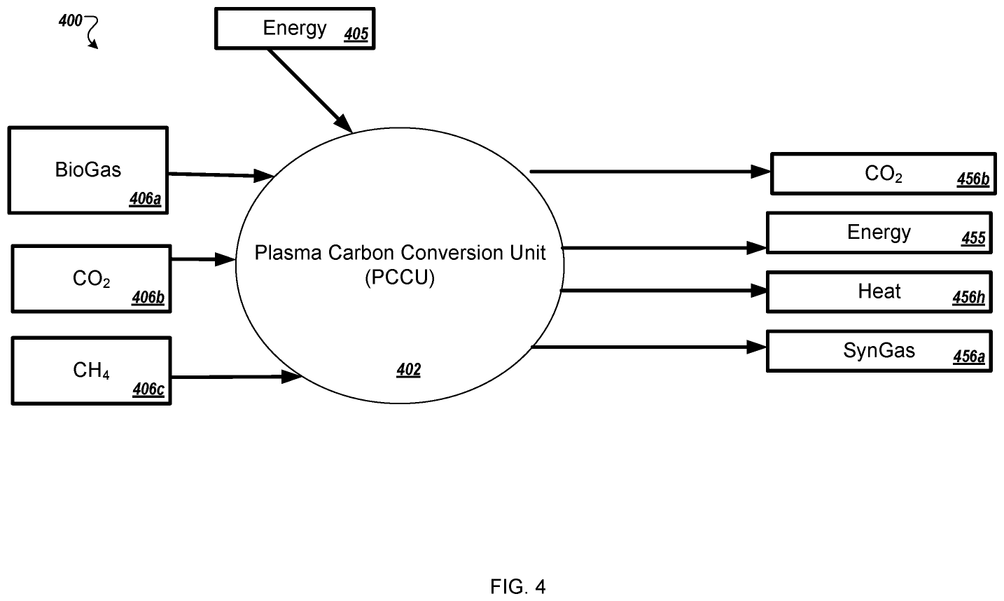

As illustrated in FIG. 4, a plasma reaction system 400 may include a plasma carbon conversion unit 402 (PCCU) that may facilitate a high temperature reaction environment to drive chemical reactions to completion. Chemical reactions for dissociating carbon dioxide 406b and/or generating various product gases, such as hydrogen gas and carbon monoxide, may be performed using the PCCU 402. The chemical reactions performed using the PCCU 402 may provide increased yields of the product gases relative to baseline amounts (which may not use the PCCU 402) because the PCCU 402 may facilitate energy for driving the formation of the product gases. Additionally or alternatively, the PCCU 402 may include unreacted (or remaining) carbon dioxide gas 456b in addition to converting the biogas 406a into synthesis gas (syngas 456a). Energy generated by the PCCU 402 may drive further operations of other processing units and/or chemical reactions. For example, excess heat from the plasma reactor (e.g., plasma chamber 310 as illustrated in FIG. 3) may be used to drive operations of integrated reformers 350, heat utilization units, compressors, or any other processes of the formation, recycling, and/or separation of various product gases.

The PCCU 402 may use various inputs including one or more of biogas 406a, carbon dioxide 406b, methane gas 406c (or any other hydrocarbon gases), and input energy to yield various outputs including one or more of carbon dioxide gas 456b, energy 455, heat 456h, syngas 456a, steam, or the like. The amount of carbon dioxide 406b included in the input stream to the PCCU 402 may be greater than the amount of carbon dioxide 456b included in the output stream of the PCCU 402. Additionally, the input energy 405 may be less than the output energy 455 yielded by the PCCU 402 because the chemical reactions occurring in the PCCU 402 may be exothermic reactions that may generate heat 456h. The energy 455 generated by the chemical reactions and/or the unreacted carbon dioxide 456b from the chemical reactions occurring in the PCCU 402 may be recycled and included in as inputs to the PCCU 402 to facilitate further chemical reactions or dissociation of carbon dioxide.

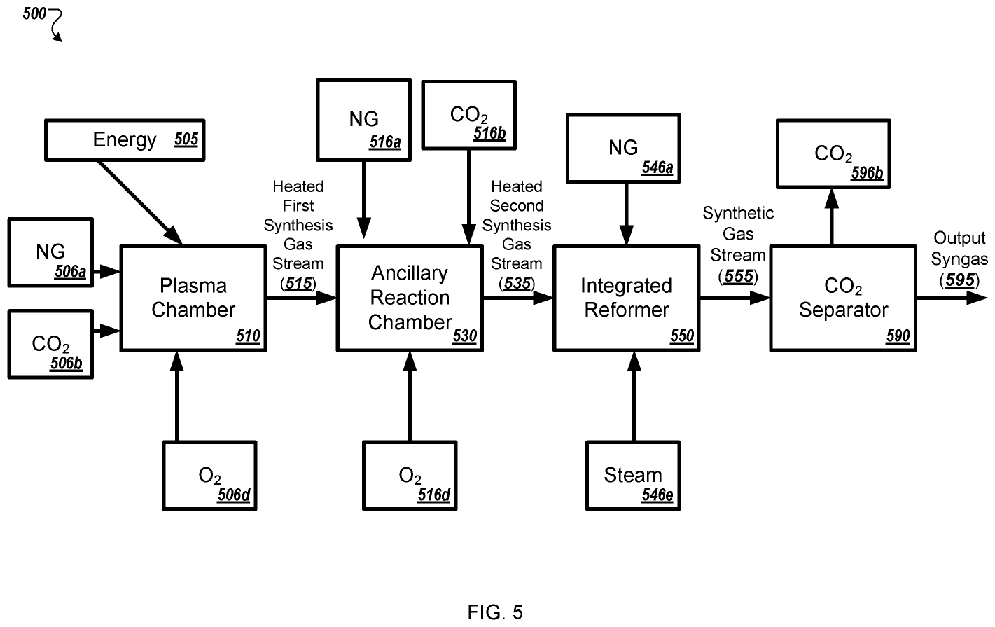

As illustrated in FIG. 5, a plasma reaction system 500 may include a PCCU (e.g., including one or more of a plasma chamber 510, an ancillary reaction chamber 530, or an integrated reformer 550) and a carbon dioxide separator 590. The plasma chamber 510 may be configured to receive a first gas stream (e.g., natural gas 506a, carbon dioxide 506b, and oxygen gas 506d) to drive production of a heated first synthesis gas stream (e.g., syngas) using energy 505.

The ancillary reaction chamber 530 may be configured to receive: (i) the heated first synthesis gas stream 515 (e.g., syngas) from the plasma chamber 510, and (ii) a second gas stream (e.g., natural gas 516a, carbon dioxide 516b, and/or oxygen gas 516d) from the one or more ancillary reaction chamber inlets. The ancillary reaction chamber 530 may be configured to drive heated second synthesis gas stream 535 (e.g., syngas) production using thermal energy produced by exothermic chemical reactions occurring in the plasma chamber 510. Heated second synthesis gas stream 535 (e.g., syngas) production occurring in the ancillary reaction chamber 530 may occur without an additional external heat input to the ancillary reaction chamber 530.

The integrated reformer 550 may be configured to receive: (i) the heated second synthesis gas stream 535 (e.g., syngas) from the ancillary reaction chamber 530, and (ii) third gas stream (e.g., natural gas 546a steam 546e) from the one or more integrated reformer inlets. The integrated reformer 550 may be configured to drive synthesis gas stream 555 (e.g., syngas) production using thermal energy produced by exothermic chemical reactions occurring in the ancillary reaction chamber 530. The integrated reformer 550 may use the thermal energy produced by the exothermic reactions occurring in the ancillary reaction chamber 530 to perform an endothermic reaction to drive the production of the synthesis gas stream 555 (e.g., syngas). Synthesis gas stream 555 (e.g., syngas) production occurring in the integrated reformer 550 may occur without an additional external heat input to the integrated reformer.

The carbon dioxide separator 590 may be configured to receive the synthesis gas stream 555 (e.g., syngas) from the integrated reformer 550. The carbon dioxide separator 590 may be configured to separate carbon dioxide 596b from the input syngas (e.g., synthesis gas stream 555 (e.g., syngas)) to generate output syngas 595.

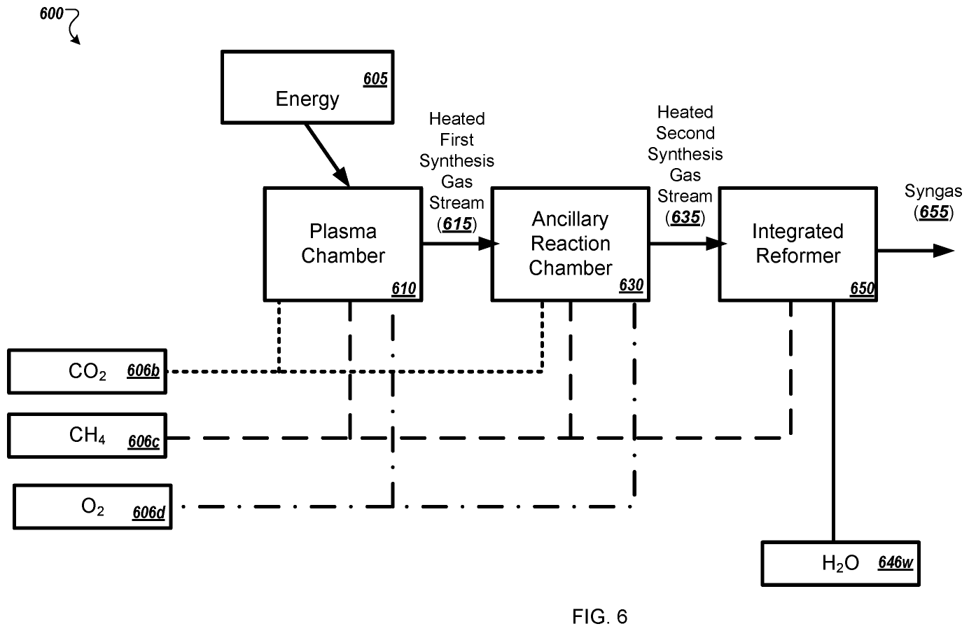

As illustrated in FIG. 6, a gas flow and energy flow diagram for a plasma reaction system 600 may include one or more of a plasma chamber 610, an ancillary reaction chamber 630, or an integrated reformer 650. The plasma chamber 610 may be configured to initiate an exothermic reaction when receiving energy 605. The plasma chamber 610 may be configured to receive one or more chemicals suitable for initiating an exothermic reaction to generate heat to be directed to the ancillary reaction chamber 630. The one or more chemicals may include CO₂ 606b, CH₄ 606c, O₂ 606d, a combination thereof, or the like.

The flow rate for the one or more chemicals may include any suitable rate for effectuating the exothermic reaction and/or an endothermic reaction. The reference input flow rate of CO₂ into the plasma chamber 610 may be from about 0.1 kg/h to about 50 kg/h. In one example, the reference input flow rate of CO₂ into the plasma chamber 610 may be from about 2 kg/h to about 10 kg/h. The reference input flow rate of CH₄ into the plasma chamber 610 may be from about 0.1 kg/h to about 50 kg/h. In one example, the reference input flow rate of CH₄ into the plasma chamber 610 may be from about 1 kg/h to about 10 kg/h. The reference input flow rate of 02 into the plasma chamber 610 may be from about 0.1 kg/h to about 50 kg/h. In one example, the reference input flow rate of 02 into the plasma chamber 610 may be from about 1 kg/h to about 10 kg/h.

The energy in the plasma chamber 610 may be increased using the energy 605 and/or the input chemicals (e.g., CH₄). The input power to the plasma chamber 610 may include a suitable amount for initiating the exothermic reaction and may include from about 0.1 kW to about 100 kW. In one example, the input power may be from about 1.0 kW to about 10 kW. The input chemicals may facilitate energy generation in any suitable amount for initiating the exothermic reaction. For example, the energy generation facilitated by the reference input flow rate of CO₂ into the plasma chamber 610 may be from about 1 kW to about 500 kW. In one example, the energy generation facilitated by the reference input flow rate of CO₂ into the plasma chamber 610 may be from about 1 kW to about 100 kW.

The ancillary reaction chamber 630 may be configured to receive a heated first synthesis gas stream 615 from the plasma chamber 610. The heated first synthesis gas stream 615 may be combined with one or more additional chemicals in the ancillary reaction chamber 630. The one or more additional chemicals may include the same chemicals input to the plasma chamber 610. The flow rate for the one or more chemicals to be directed into the ancillary reaction chamber 630 may be selected to initiate an exothermic reaction in the ancillary reaction chamber 630. The flow rate of CO₂ into the ancillary reaction chamber 630 may be from about 1 kg/h to about 1000 kg/h. In one example, the flow rate of CO₂ into the ancillary reaction chamber 630 may be from about 10 kg/h to about 250 kg/h. The flow rate of CH₄ into the ancillary reaction chamber 630 may be from about 1 kg/h to about 1000 kg/h. In one example, the flow rate of CH₄ into the ancillary reaction chamber 630 may be from about 1 kg/h to about 100 kg/h. The flow rate of 02 into the ancillary reaction chamber 630 may be from about 1 kg/h to about 500 kg/h. In one example, the flow rate of 02 into the ancillary reaction chamber 630 may be from about 1 kg/h to about 100 kg/h.

The energy in the ancillary reaction chamber 630 may increase using the energy 605 and/or the input chemicals (e.g., CH₄). The input chemicals may facilitate energy generation in any suitable amount to initiating the exothermic reaction without an additional power input to the ancillary reaction chamber 630. For example, the energy generation facilitated by the flow rate of CH₄ into the ancillary reaction chamber 630 may be from about 1 kW to about 5000 kW. In one example, the energy generation facilitated by the flow rate of CH₄ into the ancillary reaction chamber 630 may be from about 100 kW to about 1000 kW. Alternatively or in addition, the energy generation facilitated by the flow rate of the heated first synthesis gas stream 615 into the ancillary reaction chamber 630 may be from about 1 kW to about 1000 kW. In one example, the energy generation facilitated by the flow rate of the heated first synthesis gas stream 615 into the ancillary reaction chamber 630 may be from about 10 kW to about 100 kW. The flow rates for one or more of the heated first synthesis gas stream 615 or the input chemicals (e.g., CO₂, CH₄, O₂, or the like) to the ancillary reaction chamber 630 may be selected to maximize the generation of the heated second synthesis gas stream 635 for input to the integrated reformer 650.

The integrated reformer 650 may be configured to receive the heated second synthesis gas stream 635 and one or more additional chemicals (e.g., CH₄ 606c, H₂O 646w) to perform an endothermic reaction to generate syngas 655. The flow rate for the one or more chemicals to be directed into the integrated reformer 650 may be selected to perform an endothermic reaction in the integrated reformer 650. The flow rate of CH₄ into the integrated reformer 650 may be from about 1 kg/h to about 500 kg/h. In one example, the flow rate of CH₄ into the integrated reformer 650 may be from about 1 kg/h to about 100 kg/h. The flow rate of H₂O into the integrated reformer 650 may be from about 1 kg/h to about 500 kg/h. In one example, the flow rate of H₂O into the integrated reformer 650 may be from about 1 kg/h to about 100 kg/h.

The energy in the integrated reformer 650 may increase using the heated second synthesis gas stream 635 and/or the input chemicals (e.g., CH₄). The input chemicals may facilitate energy generation in any suitable amount to initiating the endothermic reaction without an additional power input to the integrated reformer 650. For example, the energy generation facilitated by the flow rate of CH₄ into the integrated reformer 650 may be from about 1 kW to about 10000 kW. In one example, the energy generation facilitated by the flow rate of CH₄ into the integrated reformer 650 may be from about 100 kW to about 5000 kW. Alternatively or in addition, the energy generation facilitated by the flow rate of the heated second synthesis gas stream 635 into the integrated reformer 650 may be from about 1 kW to about 10000 kW. In one example, the energy generation facilitated by the flow rate of heated first synthesis gas stream 615 into the integrated reformer 650 may be from about 100 kW to about 1000 kW.

The flow rates for one or more of the heated second synthesis gas stream 635 or the input chemicals (e.g., CH₄, or the like) to the integrated reformer 650 may be selected to maximize the generation of the syngas 655 for output from the integrated reformer 650. For example, the flow rate from the integrated reformer 650 for the syngas 655 may be from about 10 kg/h to about 10,000 kg/h. Alternatively or in addition, the flow rate from the integrated reformer 650 for the syngas 655 may be from about 10 kg/h to about 100 kg/h. The energy generated by the integrated reformer 650 may be from 1 kW to about 100,000 kW. In one example, the energy generated by the integrated reformer 650 may be from 100 kW to about 10,000 kW.

The energy of the syngas 655 may include any suitable ratio compared to one or more of: (i) the energy generated by the heated first synthesis gas stream 615, as output from the plasma chamber 610, or (ii) the energy generated by the heated second synthesis gas stream 635, as output from the ancillary reaction chamber 630. In one example, the energy of the syngas 655 may include a ratio of 1× to 100× the energy generated by the heated first synthesis gas stream 615. In another example, the energy of the syngas 655 may include a ratio of 1× to 10× the energy of the heated second synthesis gas stream 635.

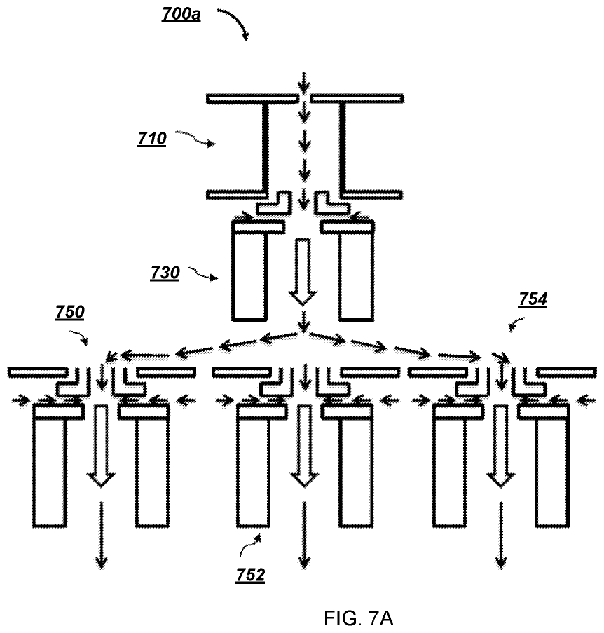

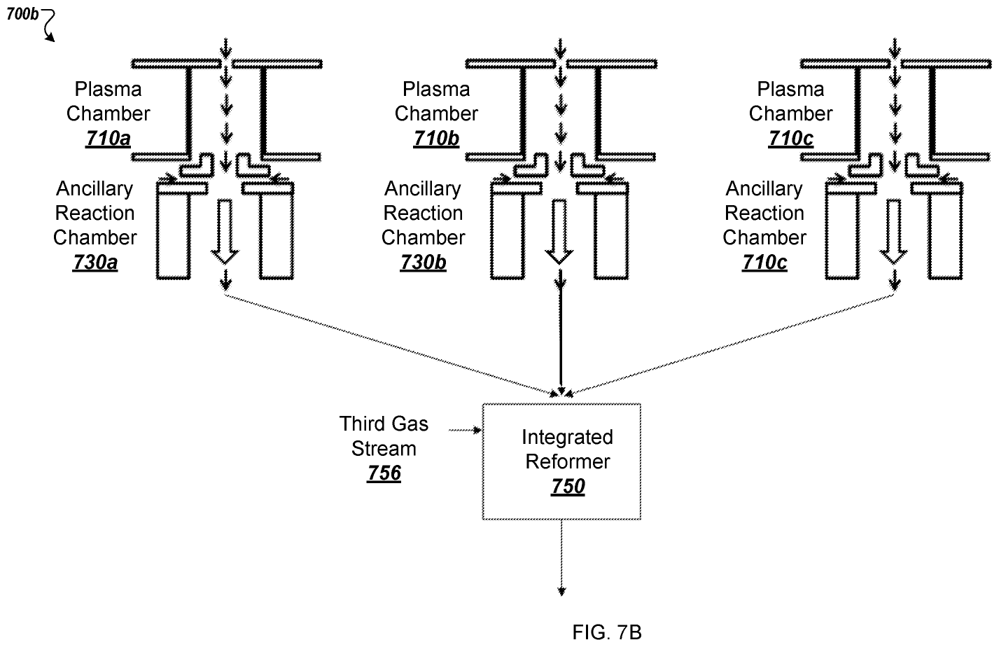

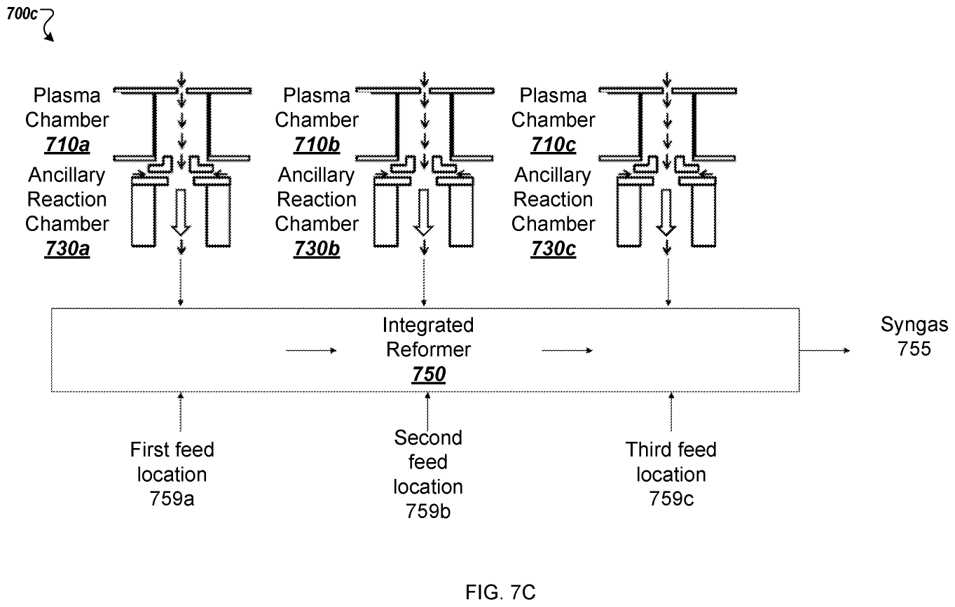

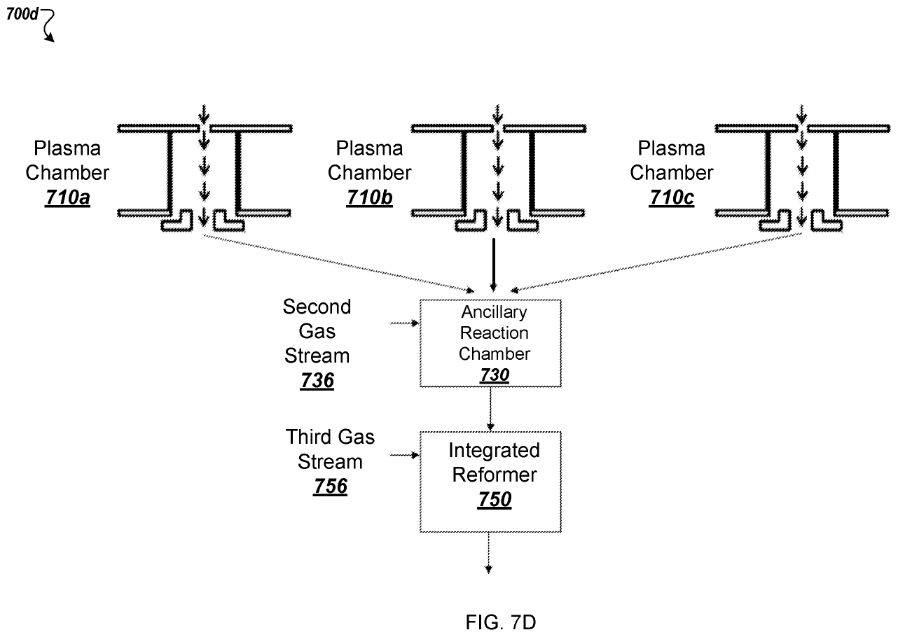

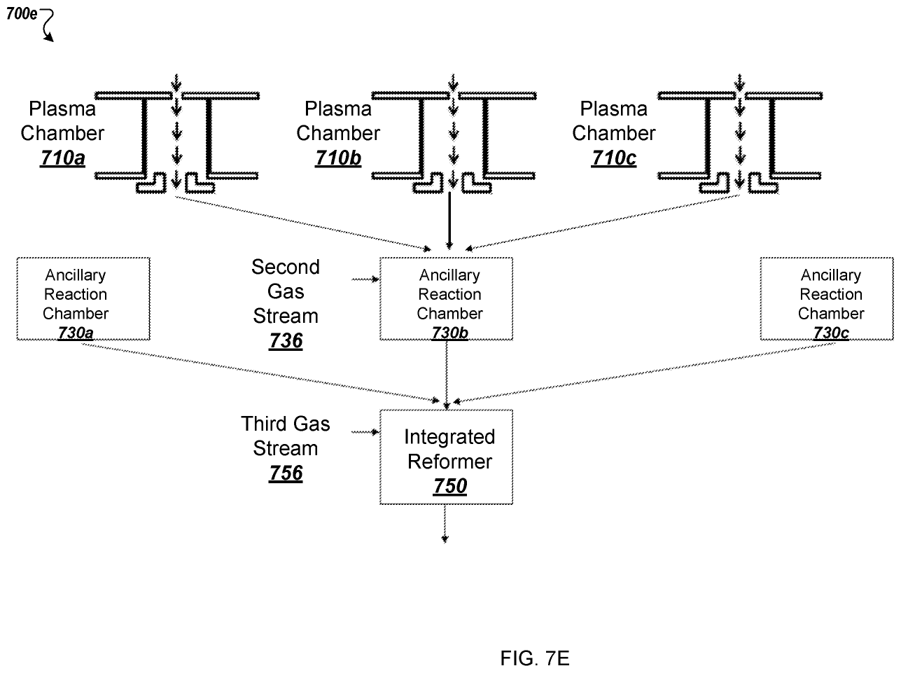

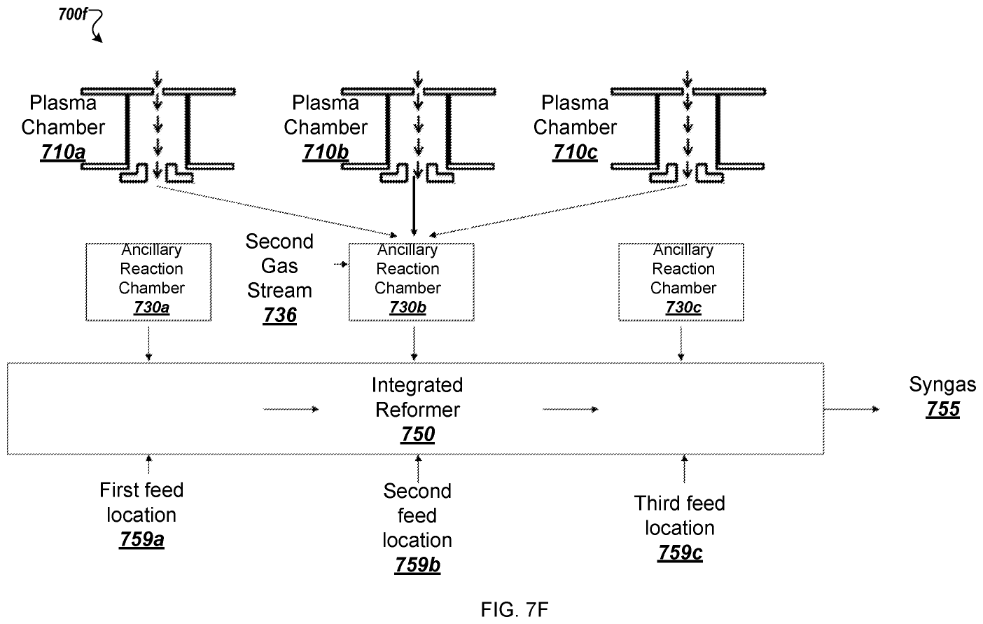

FIG. 7A is a diagram of an example plasma reaction system 700a that includes a plasma chamber 710 that may be connected to a first reaction chamber (e.g., an ancillary reaction chamber 730), and the first reaction chamber may be connected to a second reaction chamber (e.g., an integrated reformer 750), a third reaction chamber 752, and a fourth reaction chamber 754 that may be each connected in parallel with one another. Although the plasma reaction system 700a is illustrated as having the first reaction chamber in series before the second reaction chamber (e.g., an integrated reformer 750), the third reaction chamber 752, and the fourth reaction chamber 754 in parallel, an outlet flow of the plasma chamber 710 may first be obtained by the first reaction chamber, the second reaction chamber (e.g., an integrated reformer 750), the third reaction chamber 752, and/or the fourth reaction chamber 754 in parallel in a single serial stage. Additionally or alternatively, one or more reaction chambers may be configured in parallel with each other in a first serial stage with one or more reaction chambers configured in parallel in a second serial stage after the first serial stage such that any number of serial stages with any number of reaction chambers configured in parallel in each serial stage is contemplated. Additionally or alternatively, each reaction chamber that is configured in parallel in a particular serial stage may be simultaneously connected to one or more reaction chambers in a subsequent serial stage and disconnected from one or more other reaction chambers in the same subsequent serial stage.

Various reactor units may be inserted between one or more of the reaction chambers included in a chemical process involving the plasma reaction system 700a. For example, a non-plasma heat source may be inserted between two serial stages to provide supplemental heat energy to one or more of the reaction chambers. As another example, an integrated reformer, a pressure-swing adsorption unit, an air separation unit, and/or any other reactor units may be implemented to facilitate addition and/or removal of materials from the chemical process. The reaction chambers described herein may include any type of reaction chamber, including an ancillary reaction chamber, or an integrated reformer. Further, the first reaction chamber may not be present and the plasma chamber 710 may be in fluid communication with the second reaction chamber (e.g., an integrated reformer 750), the third reaction chamber 752, and/or the fourth reaction chamber 754.

Reaction chambers configured in parallel may receive gases flowing at the same or similar flow rates with the same or similar compositions. Consequently, the reaction chambers configured in parallel may operate at the same or similar temperatures and include the same or similar volumes and/or operating pressures. Additionally or alternatively, one or more of the reaction chambers configured in parallel in a particular serial stage may receive gases at a flow rate and/or composition different from the gases received by other reaction chambers in the same particular serial stage. For example, a first pipe directing gases to a first reaction chamber of a particular serial stage may include a greater diameter than a second pipe directing gases to a second reaction chamber of the particular serial stage such that the first reaction chamber receives a greater flowrate of gases than the second reaction chamber.

As illustrated in FIGS. 7A to 7F, a plasma reaction system 700a, 700b, 700c, 700d, 700e, 700f may be configured to include: (i) one or more plasma chambers (e.g., plasma chamber 710), (ii) one or more ancillary reaction chambers (e.g., ancillary reaction chamber 730), or (iii) one or more integrated reformers (e.g., integrated reformer 750).

The one or more plasma chambers may include a single plasma chamber 710 that may feed into a single ancillary reaction chamber 730 in series, as illustrated in FIG. 7A. The one or more plasma chambers may include a plurality of plasma chambers 710a, 710b, 710c that may feed separately into a plurality of ancillary reaction chambers 730a, 730b, 730c, as illustrated in FIGS. 7B and 7C. The one or more plasma chambers may include a plurality of plasma chambers 710a, 710b, 710c that may feed into a single ancillary reaction chamber 730 in series, as illustrated in FIGS. 7D-7F.

The one or more ancillary reaction chambers may include a single ancillary reaction chamber 730 that may be configured to feed into a plurality of integrated reformers 750, as illustrated in FIG. 7A. The one or more ancillary reaction chambers may include a plurality of ancillary reaction chambers 730a, 730b, 730c that may be configured to feed into a single integrated reformer 750, as illustrated in FIGS. 7B, 7C, 7E, and 7F. The one or more ancillary reaction chambers may include a plurality of ancillary reaction chambers 730a, 730b, 730c that may be configured to feed into a single integrated reformer 750 at distinct feed locations (e.g., first feed location 759a, second feed location 759b, third feed location 759c, or the like), as illustrated in FIGS. 7C and 7F, to generate syngas 755. The one or more ancillary reaction chambers may include a single ancillary reaction chamber 730 (e.g., configured to receive a second gas stream 736) that may be configured to feed into a single integrated reformer 750 (e.g., configured to receive a third gas stream 756), as illustrated in FIG. 7D. The one or more ancillary reaction chambers may include a plurality of ancillary reaction chambers 730a, 730b, 730c that may be configured to feed into a single integrated reformer 750 at a feed location, as illustrated in FIG. 7E.

The various configurations for the one or more plasma chambers, the one or more ancillary reaction chambers, and the one or more integrated reformers may be selected to maximize the energy conversion efficiency (ECE) (i.e., ECE=product energy/input energy). The one or more ancillary reaction chambers may be configured to receive one or more additional heated first synthesis gas streams from one or more additional plasma chambers (e.g., plasma chambers 710a, 710b, 710c). The one or more integrated reformers may be configured to receive one or more additional heated second synthesis gas streams from one or more additional ancillary reaction chambers (e.g., ancillary reaction chambers 730a, 730b, 730c). The one or more additional heated second synthesis gas streams may be received at one or more additional integrated reformer inlets (e.g., first feed location 759a, second feed location 759b, third feed location 759c, or the like, as illustrated in FIGS. 7C and 7F).

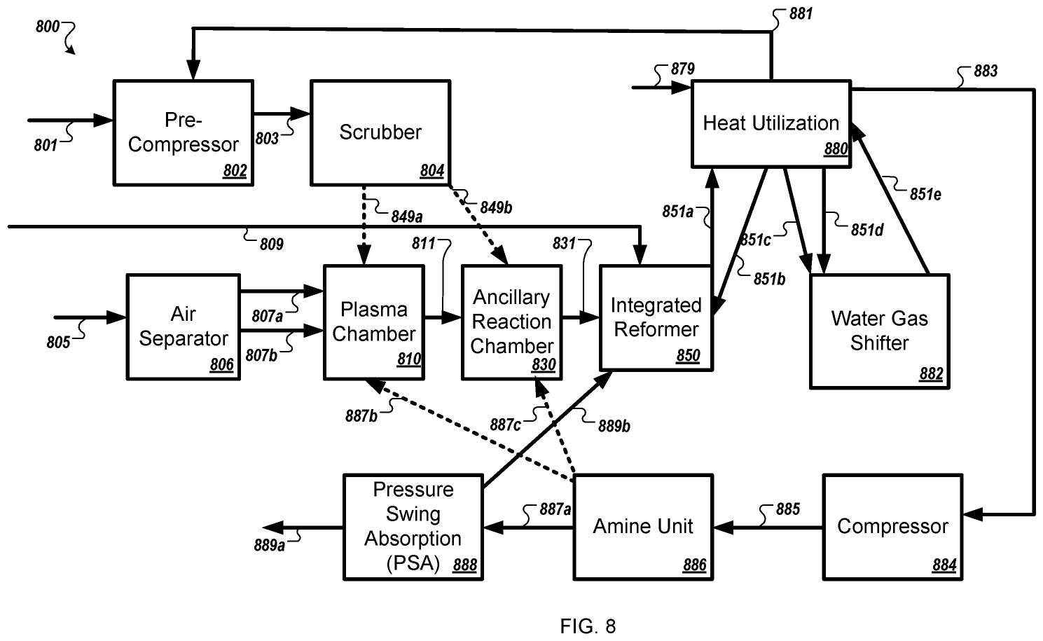

FIG. 8 is a diagram of a plasma reaction system 800 for carbon dioxide utilization using a PCCU. The carbon dioxide utilization system may include a pre-compressor unit 802 into which biogas may be inputted to increase the pressure of the input biogas 801 that may contain methane and carbon dioxide. Increasing the pressure of the input biogas 801 may be facilitated by directing power 881 from a heat utilization unit 880 to the pre-compressor unit 802. For example, the input biogas 801 may be obtained by the pre-compressor unit 802 at a pressure of 0.5 atm, 1 atm, 1.5 atm, 2 atm, or some other pressure, and the biogas 803 exiting the pre-compressor unit 802 may be at a pressure of 2 atm, 3 atm, 5 atm, 10 atm, 20 atm, 100 atm, or some other pressure. The pressurized biogas 803 may be sent to a scrubber 804 that may remove impurities, pollutants, or otherwise harmful components of the biogas. For example, the scrubber 804 may include a dry scrubbing process in which harmful substances (e.g., sulfur oxides, particulate matter, acidic gases, etc.) may be adsorbed to dry reagents included in the scrubber 804. As another example, the scrubber 804 may include a wet scrubbing process in which the biogas 803 is sprayed with a wet substance (e.g., water) to separate one or more components from the biogas 803.

An air separator 806 may obtain an input air stream 805 and separate the input air stream 805 into its constituent components, which may primarily include nitrogen gas and oxygen gas. The air separator 806 may facilitate separation of the components included in the input air stream 805 via one or more of fractional distillation, pressure swing adsorption, vacuum pressure swing adsorption, membrane separation, or by any other separation methods. The separated air components 807a, 807b may be sent to a plasma chamber 810 of a PCCU that may include one or more of a plasma chamber 810, an ancillary reaction chamber 830, or an integrated reformer 850.

The scrubbed biogas 849 may be sent to the plasma chamber 810 and the ancillary reaction chamber 830 of the PCCU. The plasma reactor may include a plasma chamber 810 made of a quartz or ceramic material in which one or more waveguides are configured to facilitate chemical reactions that occur in the plasma chamber 810. Fuel (e.g., hydrocarbon such as natural gas or methane) and other input compounds heated by electricity or microwaves may react to provide more heat to input compounds of the plasma chamber 810. The plasma chamber 810 may be configured to obtain an inlet stream of scrubbed biogas 849a, the separated air components 807a, 807b, and carbon dioxide 887b from an amine unit 886 to affect chemical reactions between the inlet streams of gases. For example, incoming scrubbed biogas 849a may react with the incoming carbon dioxide 887b and oxygen 807b at high temperatures provided by the electrically heated plasma to form syngas 811 and excess heat that are then sent to the ancillary reaction chamber 830.

The ancillary reaction chamber 830 may be configured to obtain syngas 811 from the plasma chamber 810, scrubbed biogas 849b, and carbon dioxide 887c from an amine unit 886 to affect chemical reactions between the inlet stream of gases. For example, in the ancillary reaction chamber 830, incoming scrubbed biogas 849b may react with the incoming carbon dioxide 887c at high temperatures provided by the heat generated (e.g., from an exothermic reaction) by the plasma chamber 810 to form syngas 831 and excess heat that are then sent to the integrated reformer 850. In this and other examples, the oxygen gas obtained from the air separator 806 may facilitate reaction between the scrubbed biogas and the carbon dioxide.

The integrated reformer 850 may include a steam methane reforming reactor (SMR) or any other reactor vessel that may be configured to convert hydrocarbon included in the natural gas 809 into hydrogen and carbon monoxide using electrically generated or microwave generated heat (e.g., the heat provided by the plasma chamber 810) and chemical reaction heat (e.g., heat provided by the plasma chamber and ancillary reaction chamber) rather than combusted natural gas or other fuels. Additionally or alternatively, the integrated reformer 850 may be configured to generate additional syngas using natural gas 809. The integrated reformer 850 may be configured to obtain a recycled stream of steam 851b from the heat utilization unit 880 in which the recycle streams provide additional reactants to facilitate a greater conversion rate of hydrocarbon and biogas into one or more product gases.

The syngas 851a produced by the integrated reformer 850 may be sent to the heat utilization unit 880, which may yield a cooled product gas 851c and steams of steam 851b and 851d. The heat utilization unit 880 may include a steam-generating or a power-generating unit that may be configured to receive an input stream of water 879 and the syngas 851a generated by the integrated reformer 850. The heat utilization unit 880 may vaporize the input water 879 using the excess heat generated by the PCCU and input to the heat utilization unit 880 by the incoming syngas 851a stream from the integrated reformer 850, and the generated steam 851d may be sent to a water-gas shifter (WGS) 882. Some of the syngas 851a sent to the heat utilization unit 880 from the integrated reformer 850 may be routed to the WGS 882 (851c). The WGS 882 may facilitate formation of hydrogen gas via a water-gas shift reaction in which carbon monoxide and water reversibly react to form carbon dioxide and hydrogen that are sent back to the heat utilization unit 880 (851e). Additionally or alternatively, any excess steam 851b from the heat utilization unit 880 may be sent to the integrated reformer 850 to recycle any excess heat to facilitate the formation of the syngas 851a in the integrated reformer 850.

The hydrogen gas and any unreacted or partially reacted materials may be sent from the heat utilization unit 880 to a compressor 884 that pressurizes the input materials 883 and sends the output gases 885 to an amine unit 886. Increasing the pressure of the input materials 883 may be facilitated by excess power obtained from the heat utilization unit 880. For example, the input materials 883 may be obtained by the compressor at a pressure of 0.5 atm, 1 atm, 1.5 atm, 2 atm, or some other pressure, and the hydrogen gas and/or any other gases exiting the compressor 884 may be at a pressure of 2 atm, 3 atm, 5 atm, 10 atm, 20 atm, 100 atm, or some other pressure.

The amine unit 886 may include various aqueous solutions of amines that may react with the gases 885 exiting the compressor 884 to remove any remaining impurities (e.g., hydrogen sulfide, sulfur oxides, or any other harmful substances). Additionally or alternatively, the amines included in the amine unit 886 may facilitate removal of acidic gases, such as the carbon dioxide. The carbon dioxide 887b, 887c removed by the amine unit 886 may be recycled and sent back to the plasma chamber 810 and/or the ancillary reaction chamber 830 to facilitate further syngas reactions. Any partially reacted or unreacted gases that may have entered the amine unit 886 alongside the hydrogen gas product may be redirected back to the integrated reformer 850 in a recycle stream of biogas 849 to drive the chemical reactions relating to formation of the syngas 851a and/or the hydrogen gas product to a further degree of completion.

The remaining hydrogen gas and any residual gases from the amine unit 886 may be sent to a pressure swing adsorption unit 888 (PSA) to further separate the obtained gases 887a to generate a high purity H₂ 889a. For example, the pressure swing adsorption unit 888 may include a membrane of adsorbent materials that may separate the hydrogen gas from any other gases that entered the pressure swing adsorption unit 888 by catching compounds passing through the membrane aside from the hydrogen gas. The gases caught by the membrane may be desorbed from the adsorbent materials by reducing the pressure in the pressure swing adsorption unit 888, and the desorbed gases 889b may be recycled into the PCCU (e.g., to the integrated reformer 850) for further reacting.

Modifications, additions, or omissions may be made to the system of carbon dioxide utilization without departing from the scope of the present disclosure. For example, the designations of different elements in the manner described is meant to help explain concepts described herein and is not limiting. For instance, in some embodiments, the pre-compressor unit 802, scrubber 804, air separator 806, PCCU including the plasma chamber 810, the ancillary reaction chamber 830, and the integrated reformer 850, heat utilization unit 880, WGS 882, compressor 884, amine unit 886, and pressure swing adsorption unit 888 are delineated in the specific manner described to help with explaining concepts described herein but such delineation is not meant to be limiting. Further, the system of carbon dioxide utilization may include any number of other elements or may be implemented within other systems or contexts than those described.

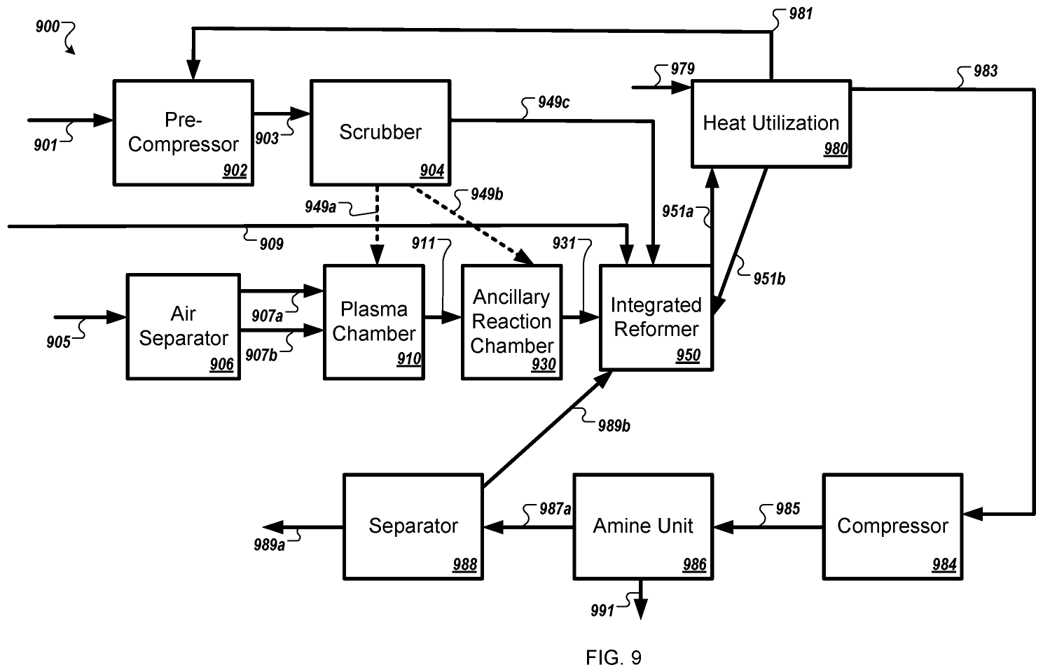

FIG. 9 is a diagram of a plasma reaction system 900 of synthesizing hydrogen gas and carbon monoxide using a PCCU. The carbon dioxide utilization system may include a pre-compressor unit 902 into which biogas may be inputted to increase the pressure of the input biogas 901 that may contain methane and carbon dioxide. Increasing the pressure of the input biogas 901 may be facilitated by directing power 981 from a heat utilization unit 980 to the pre-compressor unit 902. For example, the input biogas 901 may be obtained by the pre-compressor unit 902 at a pressure of 0.5 atm, 1 atm, 1.5 atm, 2 atm, or some other pressure, and the biogas 903 exiting the pre-compressor unit 902 may be at a pressure of 2 atm, 3 atm, 5 atm, 10 atm, 20 atm, 100 atm, or some other pressure. The pressurized biogas 903 may be sent to a scrubber 904 that may remove impurities, pollutants, or otherwise harmful components of the biogas. For example, the scrubber 904 may include a dry scrubbing process in which harmful substances (e.g., sulfur oxides, particulate matter, acidic gases, etc.) are adsorbed to dry reagents included in the scrubber 904. As another example, the scrubber 904 may include a wet scrubbing process in which the biogas is sprayed with a wet substance (e.g., water) to separate one or more components from the biogas 903. The scrubbed biogas 949 may be sent to a plasma chamber 910, an ancillary reaction chamber 930, and/or an integrated reformer 950 of a PCCU.

An air separator 906 may obtain an input air stream 905 and separate the input air stream 905 into its constituent components, which may primarily include nitrogen gas and oxygen gas. The air separator 906 may facilitate separation of the components included in the input air stream 905 via fractional distillation, pressure swing adsorption, vacuum pressure swing adsorption, membrane separation, or by any other separation methods. The separated air components 907a, 907b may be sent to the PCCU that may include the plasma chamber 910, the ancillary reaction chamber 930, and/or the integrated reformer 950.

The plasma chamber 910 may be made of a quartz or ceramic material in which one or more waveguides may be configured to facilitate chemical reactions that may occur in the plasma chamber 910. Fuel (e.g., hydrocarbon) and other input compounds heated by electricity or microwaves may react to provide more heat to input compounds of the plasma reactor. The plasma chamber 910 may be configured to obtain an inlet stream of the separated air components 907a, 907b and scrubbed biogas 949a from the scrubber. The oxygen gas obtained from the air separator 906 and the energy provided in the plasma reactor may facilitate conversion of the scrubbed biogas 949a into syngas 911.

The ancillary reaction chamber 930 may be configured to obtain syngas 911 from the plasma chamber 910 and scrubbed biogas 949b to affect chemical reactions between the inlet stream of gases. For example, in the ancillary reaction chamber 930, incoming biogas 949b may react at high temperatures provided by the heat generated (e.g., from an exothermic reaction) by the plasma chamber 910 to form syngas 931 and excess heat that may be sent to the integrated reformer 950.

The integrated reformer 950 may include a steam methane reforming reactor (SMR) or any other reactor vessel that is configured to obtain the scrubbed biogas 949c from the scrubber 904 and/or natural gas 909, and convert it into syngas 951a using electrically generated or microwave-generated heat and chemical reaction heat (e.g., the heat provided by one or more of the plasma chamber 910 or the ancillary reaction chamber 930). Additionally or alternatively, the integrated reformer 950 may be configured to obtain a recycle stream of waste gas from a separator unit 988 and/or a recycled stream of steam 951b from the heat utilization unit 980 in which the recycle streams from the separator unit 988 and the heat utilization unit 980 provide additional reactants to facilitate a greater conversion rate of biogas into syngas 951a. The syngas 951a yielded by chemical reactions occurring in the PCCU may be generated more efficiently than syngas yielded by other existing chemical processes. Additionally or alternatively, additional heat may not be used to facilitate the syngas reactions occurring in the integrated reformer 950 because the heat generated by the reactions occurring in the plasma chamber 910 and/or the ancillary reaction chamber 930 may be inputted into the integrated reformer 950.

The syngas 951a produced by the integrated reformer 950 may be sent to the heat utilization unit 980, which may yield one or more product gases 983 derived from the syngas 951a. The heat utilization unit 980 may include a steam-generating or a power-generating unit that may be configured to receive an input stream of water 979 and the syngas 951a generated by the integrated reformer 950. The heat utilization unit 980 may vaporize the input water 979 using the excess heat generated by the PCCU and input to the heat utilization unit 980 by the incoming syngas 951a stream from the integrated reformer 950, and the generated steam 951b may facilitate production of the syngas product gases 951a in the integrated reformer 950.

Any excess steam 951b from the heat utilization unit 980 may be sent to the integrated reformer 950 to recycle any excess heat to facilitate the formation of the syngas 951a in the integrated reformer 950. The product gases yielded from the syngas 951a may include hydrogen gas and carbon monoxide in a ratio ranging from 0.5:1 to 2.9:1. The ratio of product gases from the heat utilization unit 980 may be dependent on a volume and composition of input biogas 901 into the pre-compressor unit 902, a volume of input air stream 905 into the air separator 906, an amount of energy supplied to the plasma chamber 910 of the PCCU, an amount of steam 951b sent to the integrated reformer 950 from the heat utilization unit 980, or some combination thereof. For example, a ratio of hydrogen gas to carbon monoxide may range from approximately 0.5:1 to approximately 1.5:1 when there is no recycle stream of steam 951b from the heat utilization unit 980 to the integrated reformer 950, while the ratio of hydrogen gas to carbon monoxide may increase to approximately 1.3:1 to approximately 2.9:1 depending on the amount of steam 951b recycled to the integrated reformer 950.

The product gases 983 and any unreacted or partially reacted materials may be sent from the heat utilization unit 980 to a compressor 984 that pressurizes the product gases 983 (and any other input materials) and outputs pressurized product gases 985 to an amine unit 986. Increasing the pressure of the product gases 983 may be facilitated by excess heat obtained from the heat utilization unit 980. For example, the product gases 983 may be obtained by the compressor 984 at a pressure of 0.5 atm, 1 atm, 1.5 atm, 2 atm, or some other pressure, and the hydrogen gas and/or any other gases exiting the compressor 984 may be at a pressure of 2 atm, 3 atm, 5 atm, 10 atm, 20 atm, 100 atm, or some other pressure.

The amine unit 986 may include various aqueous solutions of amines that may react with the pressurized product gases 985 exiting the compressor 984 to remove any remaining impurities (e.g., hydrogen sulfide, sulfur oxides, or any other harmful substances). Additionally or alternatively, the amines included in the amine unit 986 may facilitate removal of acidic gases, such as the carbon dioxide. The carbon dioxide 991 removed by the amine unit 986 may be sent to another reactor unit or processing system, such as the system of carbon dioxide utilization.

The pressurized product gases 985 treated at the amine unit 986 may be sent to a separator unit 988 that splits the various components of the product gases 987a. As such, any partially reacted or unreacted gases that entered the separator unit 988 alongside the product gases may be redirected back to the integrated reformer 950 in a recycle stream 989b to drive the chemical reactions relating to formation of the syngas 951a to a further degree of completion. Additionally or alternatively, the separator unit 988 may include a fractional distillation system, a vacuum pressure swing adsorption system, or any other separation processes that may be designed to separate the product gases 989a (e.g., H₂ and CO) from unreacted or partially reacted component gases. The separated product gases 989a may also be divided from one another such that different product gases may be directed to different locations (e.g., different storage containers).

Modifications, additions, or omissions may be made to the system of synthesizing hydrogen gas and carbon monoxide without departing from the scope of the present disclosure. For example, the designations of different elements in the manner described is meant to help explain concepts described herein and is not limiting. For instance, in some embodiments, the pre-compressor unit 902, scrubber 904, air separator 906, PCCU including the plasma chamber 910, the ancillary reaction chamber 930, and/or the integrated reformer 950, heat utilization unit 980, compressor 984, amine unit 986, and separator unit 988 may be delineated in the specific manner described to help with explaining concepts described herein but such delineation is not meant to be limiting. Further, the system of synthesizing hydrogen gas and carbon monoxide may include any number of other elements or may be implemented within other systems or contexts than those described.

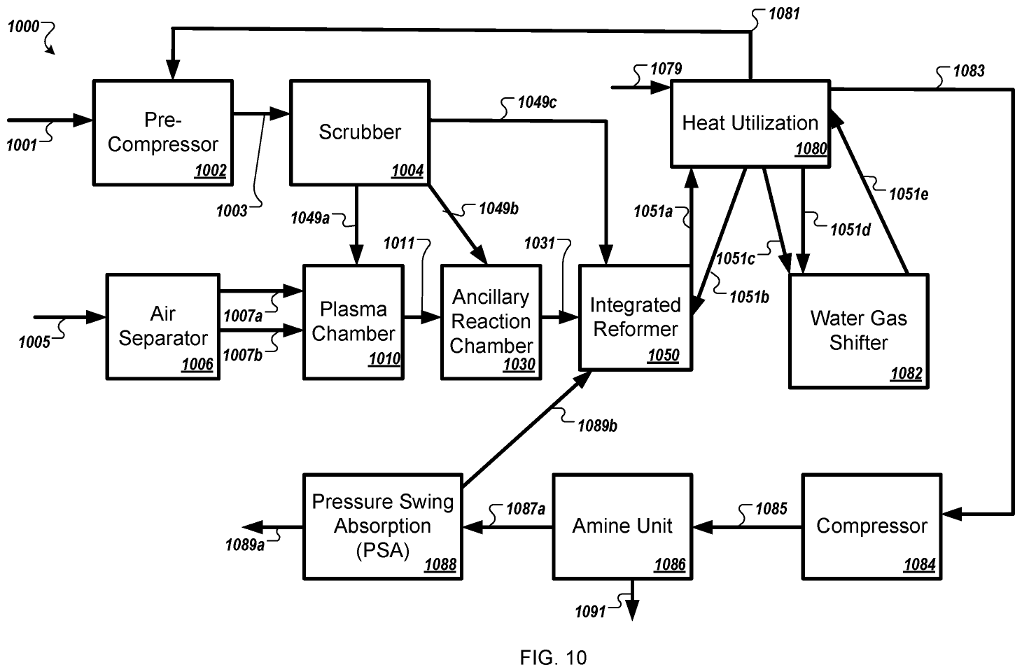

FIG. 10 is a diagram of a plasma reaction system 1000 of converting biogas into hydrogen gas using a PCCU. The carbon dioxide utilization system may include a pre-compressor unit 1002 into which input biogas 1001 may be inputted. Increasing the pressure of the input biogas 1001 may be facilitated by directing power from a heat utilization unit 1080 to the pre-compressor unit 1002. For example, the input biogas 1001 may be obtained by the pre-compressor unit 1002 at a pressure of 0.5 atm, 1 atm, 1.5 atm, 2 atm, or some other pressure, and the biogas 1003 exiting the pre-compressor unit 1002 may be at a pressure of 2 atm, 3 atm, 5 atm, 10 atm, 20 atm, 100 atm, or some other pressure. The pressurized biogas 1003 may be sent to a scrubber 1004 that may remove impurities, pollutants, or otherwise harmful components of the biogas. For example, the scrubber 1004 may include a dry scrubbing process in which harmful substances (e.g., sulfur oxides, particulate matter, acidic gases, etc.) may be adsorbed to dry reagents included in the scrubber 1004. As another example, the scrubber 1004 may include a wet scrubbing process in which the biogas is sprayed with a wet substance (e.g., water) to separate one or more components from the biogas 1003.

An air separator 1006 may obtain an input air stream 1005 and separate the input air stream 1005 into its constituent components 1007a, 1007b, which may primarily include nitrogen gas 1007a and oxygen gas 1007b. The air separator 1006 may facilitate separation of the components included in the input air stream 1005 via fractional distillation, pressure swing adsorption, vacuum pressure swing adsorption, membrane separation, or by any other separation methods. The separated air components 1007a, 1007b may be sent to a PCCU that may include a plasma chamber 1010, an ancillary reaction chamber 1030, and an integrated reformer 1050.

The plasma chamber 1010 may be made of a quartz or ceramic material in which one or more waveguides are configured to facilitate chemical reactions that occur in the plasma chamber 1010. Fuel (e.g., hydrocarbon) and other input compounds heated by electricity or microwaves may react to provide more heat to input compounds of the plasma chamber 1010. The plasma chamber 1010 may be configured to obtain an inlet stream of the separated air components 1007a, 1007b and scrubbed biogas 1049a from the scrubber 1004. The oxygen gas obtained from the air separator 1006 and the energy provided in the plasma chamber 1010 may facilitate conversion of the scrubbed biogas 1049a into syngas 1011.

The ancillary reaction chamber 1030 may be configured to obtain syngas 1011 from the plasma chamber 1010 to affect chemical reactions between the inlet stream of gases. For example, in the ancillary reaction chamber 1030, incoming scrubbed biogas 1049b may react at high temperatures provided by the heat generated (e.g., from an exothermic reaction) by the plasma chamber 1010 to form syngas 1031 and excess heat that may be sent to the integrated reformer 1050.

The integrated reformer 1050 may be a discrete reaction unit that may be connected to the ancillary reaction chamber 1030. The integrated reformer 1050 may include a steam methane reforming reactor (SMR) or any other reactor vessel that is configured to obtain the scrubbed biogas 1049c from the scrubber 1004 and convert it into syngas 1051a using electrically generated or microwave-generated heat and chemical reaction heat (e.g., the heat provided by the plasma chamber 1010 and/or the ancillary reaction chamber 1030). Additionally or alternatively, the integrated reformer 1050 may be configured to obtain a recycle stream 1089b of syngas from a PSA unit 1088 and/or a recycled stream of steam 1051b from the heat utilization unit 1080 in which the recycle streams from the PSA unit 1088 and the heat utilization unit 1080 provide additional reactants to facilitate a greater conversion rate of biogas into syngas 1051a.

The syngas 1051a produced by the integrated reformer 1050 may be sent to the heat utilization unit 1080, which yields one or more cooled product gases 1051c derived from the syngas 1051a and 1083 derived from the syngas 1051e. The heat utilization unit 1080 may include a steam-generating or a power-generating unit that may be configured to receive an input stream of water 1079, the syngas 1051a generated by the integrated reformer 1050, and the syngas 1051e from a water gas shifter (WGS). The heat utilization unit 1080 may vaporize the input water 1079 using the excess heat generated by the PCCU and input to the heat utilization unit 1080 by the incoming syngas 1051a stream from the integrated reformer 1050, and the generated steam 1051b may facilitate conversion of the biogas 1049c into the product gases (e.g., syngas 1051a). Additionally or alternatively, any excess steam 1051b from the heat utilization unit 1080 may be sent to the integrated reformer 1050 to recycle the heat to facilitate further formation of the syngas 1051a in the integrated reformer 1050.

The heat utilization unit 1080 may vaporize the water 1079 using the excess heat generated by the PCCU and input to the heat utilization unit 1080 by the incoming syngas 1051a stream from the integrated reformer 1050, and the generated steam 1051d and syngas 1051c may be sent to a water-gas shifter (WGS) 1082. Additionally or alternatively, excess steam 1051b from the heat utilization unit 1080 may be sent to the integrated reformer 1050 to recycle the excess heat to facilitate the formation of the syngas 1051a in the integrated reformer 1050.

Some of the syngas 1051a sent to the heat utilization unit 1080 from the integrated reformer 1050 may be routed to the WGS 1082 (1051c). The WGS 1082 may facilitate formation of hydrogen gas via a water-gas shift reaction in which carbon monoxide and water reversibly react to form carbon dioxide and hydrogen gas that are sent back to the heat utilization unit 1080 (1051e).

In these and other embodiments, the product gases 1083 (e.g., the hydrogen gas generated in the WGS 1082) and any unreacted or partially reacted materials may be sent from the heat utilization unit 1080 to a compressor 1084 that pressurizes the product gases (and any other input materials) and sends the pressurized product gases 1085 to an amine unit 1086. Increasing the pressure of the product gases 1083 may be facilitated by excess power 1081 obtained from the heat utilization unit 1080. For example, the product gases 1083 may be obtained by the compressor at a pressure of 0.5 atm, 1 atm, 1.5 atm, 2 atm, or some other pressure, and the pressurized product gases 1085 (e.g., hydrogen gas and/or any other gases) exiting the compressor 1084 may be at a pressure of 2 atm, 3 atm, 5 atm, 10 atm, 20 atm, 100 atm, or some other pressure.

The amine unit 1086 may include various aqueous solutions of amines that react with the pressurized product gases 1085 exiting the compressor 1084 to remove any remaining impurities (e.g., hydrogen sulfide, sulfur oxides, or any other harmful substances). Additionally or alternatively, the amines included in the amine unit 1086 may facilitate removal of acidic gases, such as the carbon dioxide. The carbon dioxide 1091 removed by the amine unit 1086 may be sent to another reactor unit or processing system, such as the system of carbon dioxide utilization.

The product gases 1087a treated at the amine unit 1086 may be sent to the PSA unit 1088 that splits the various components of the product gases 1087a. For example, the PSA unit 1088 may separate the components included in the product gases in which the PSA unit 1088 includes a membrane of adsorbent materials that separates gas components that entered the PSA unit 1088 by filtering compounds passing through the membrane. The gases caught by the membrane may be desorbed from the adsorbent materials by reducing the pressure in the PSA unit 1088, and the desorbed gases may be recycled into the PCCU (e.g., to the integrated reformer 1050) for further reacting. As such, any partially reacted or unreacted gases that entered the separator unit alongside the product gases may be redirected back to the integrated reformer 1050 in a recycle stream 1089b to drive the chemical reactions relating to formation of the syngas 1051a to a further degree of completion. Additionally or alternatively, the separated product gases may be divided from one another such that different product gases 1089a may be directed to different locations (e.g., different storage containers).

Modifications, additions, or omissions may be made to the system of converting biogas into hydrogen gas without departing from the scope of the present disclosure. For example, the designations of different elements in the manner described is meant to help explain concepts described herein and is not limiting. For instance, in some embodiments, the pre-compressor unit 1002, scrubber 1004, air separator 1006, PCCU including the plasma chamber 1010, the ancillary reaction chamber 1030, and/or the integrated reformer 1050, heat utilization unit 1080, WGS 1082, compressor 1084, amine unit 1086, and PSA Unit 1088 are delineated in the specific manner described to help with explaining concepts described herein but such delineation is not meant to be limiting. Further, the system of converting biogas into hydrogen gas may include any number of other elements or may be implemented within other systems or contexts than those described.

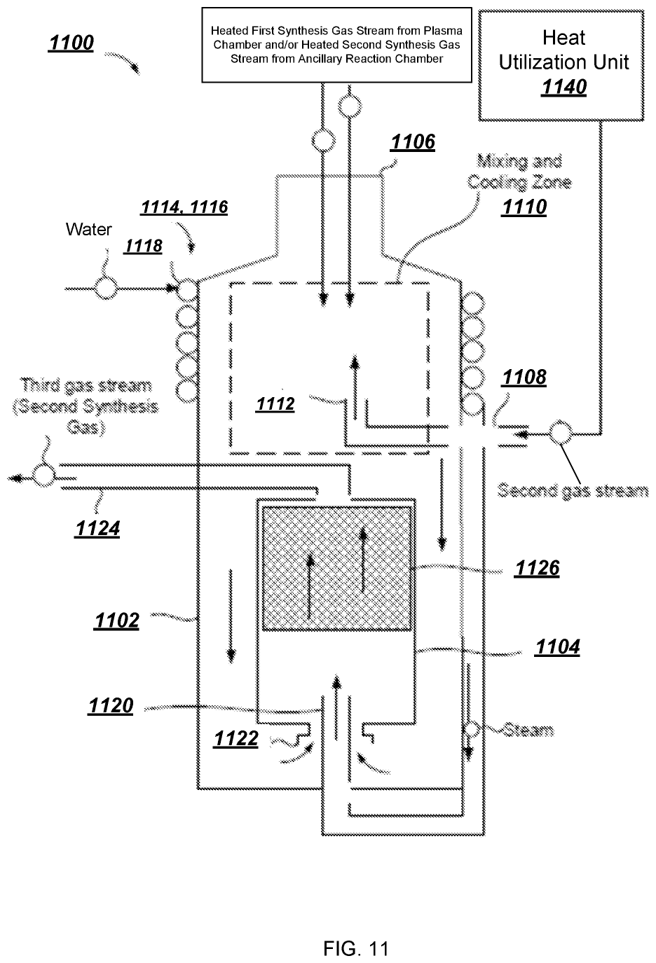

FIG. 11 illustrates an example of an integrated reformer 1100. The integrated reformer 1100 may obtain one or more gaseous compounds from a plasma chamber. The gaseous compounds obtained from the plasma chamber may be heated to a high temperature due to exothermic reactions in the plasma chamber. As such, excess heat from the plasma chamber may be transferred to the integrated reformer 1100 by the gaseous compounds outputted by the plasma chamber. In some embodiments, the integrated reformer 1100 may include an outer chamber and an inner reaction chamber in which the gaseous compounds flow from the outer chamber into the inner reaction chamber. Additionally or alternatively, water and/or steam may be fed into the integrated reformer 1100 such that the water and/or the steam flow from the outer chamber into the inner reaction chamber or are fed directly into the inner reaction chamber. The integrated reformer 1100 may output syngas using outlet 1124 or other gaseous products, which may be sent to one or more processing units to further treat the gaseous products.

FIG. 11 illustrates a cross-sectional view of an example integrated reformer 1100. The integrated reformer 1100 may include an outer chamber 1102 and the reaction chamber 1104. The outer chamber 1102 may include a first inlet 1106 configured to obtain a first gas stream (e.g., gas stream including a heated second synthesis gas stream from an ancillary reaction chamber) and a second inlet 1108 configured to obtain a second gas stream (e.g., gas stream including hydrocarbon fuel such as biogas, CH₄, natural gas, or any combinations thereof). The second gas stream may be from a heat utilization unit 1140 (e.g., heat utilization unit similar to the heat utilization unit 880, 980, and 1080 in FIGS. 8, 9, and 10, respectively). The second gas stream may be heated or cooled by the heat utilization unit 1140 to a pre-determined temperature before being directed to the outer chamber 1102.

The integrated reformer 1100 may provide a mixing and cooling zone 1110 in the outer chamber 1102 where the first gas stream and the second gas stream may be mixed and cooled. To mix the first gas stream and the second gas stream together in the mixing and the cooling zone 1110, a first end 1112 of the second inlet 1108 may be extended into the mixing and cooling zone 1110 via a wall of the outer chamber 1102. The first end 1112 of the second inlet 1108 in the outer chamber 1102 may be bent so that the first end 1112 of the second inlet 1108 may be directed to the first inlet 1106. The first gas stream and the second gas stream may collide directly at the mixing and the cooling zone 1110 for better mixing.

The first gas stream may be from a plasma chamber and/or an ancillary reaction chamber such that the first output stream (including the heated second synthesis gas stream 635 from the ancillary reaction chamber, as described in relation to FIG. 6). The first output stream (e.g., first gas stream in FIG. 11) from the plasma chamber may have a high temperature (e.g., temperature range between 1500° C. and 2500° C.) due to operations in the plasma chamber.

By mixing the first gas stream (with the high temperature) with the second gas stream (biogas in this example) with a temperature relatively lower than the first gas stream, the temperature of the mixture of the first gas stream and the second gas stream may be lower than the temperature of the first gas stream. To efficiently cool down the mixture of the first gas stream and the second gas stream to a predetermined temperature or a predetermined temperature range so that the temperature of the mixture of the first gas stream and the second gas stream is within a range (e.g., between 700° C. and 1000° C.) suitable for steam reforming (in the reaction chamber 1104 along with steam), a cooling unit 1114 may be coupled to the outer chamber 1102.

The integrated reformer 1100 may include the cooling unit 1114 disposed adjacent to mixing and cooling zone 1110. The cooling unit 1114 may surround the mixing and cooling zone 1110. The cooling unit 1114 may include a tube 1116 (or a pipe) disposed or wrapped around the outer chamber 1102 adjacent to the mixing and cooling zone 1110. The mixing and cooling zone 1110 may be positioned between the first inlet 1106 and the reaction chamber 1104.

The cooling unit 1114 may use water as coolant to cool down the mixture of the first gas stream and/or the second gas stream. For example, water may be supplied to a first end 1118 of the tube 1116 disposed around the outer chamber 1102. As the water flows within the tube 1116, the water may absorb the thermal energy (heat) from the mixture of the first gas stream and/or the second gas stream, and becomes steam (e.g., water in gas state).

The cooling unit 1114 may be configured to provide the steam to the reaction chamber 1104. A second end 1120 of the tube 1116 may be disposed in the reaction chamber 1104 adjacent to a mixture gas inlet 1122 of the reaction chamber 1104. The second end 1120 of the tube 1116 may be connected to (or in fluid communication with) the reaction chamber 1104 via the mixture gas inlet 1122 of the reaction chamber 1104.

The second end 1120 of the tube 1116 may be directed to a side opposite to the side of the mixture gas inlet 1122. The mixture of the first gas stream and the second gas stream may be provided to the reaction chamber 1104 via the mixture gas inlet 1122. As a result, the mixture of the first gas stream and the second gas stream may be mixed with the steam in the reaction chamber 1104. As a result, the reaction chamber 1104 may generate a third gas stream based on the first gas stream, the second gas streams, and the steam using the steam reforming. The reaction chamber 1104 may include an outlet 1124 to output the third gas stream (including the syngas) generated by the integrated reformer 1100. The reaction chamber 1104 may include a catalyst 1126 to promote more reactions for synthesis gas production (e.g., catalytic process). The catalyst may include a porous material or structure (e.g., mesh, plurality of tubes or pipes, membrane). The catalyst 1126 may be disposed between the outlet 1124 and the mixture gas inlet 1122 so the mixtures of the first gas stream, the second gas steam, and the steam from the cooling unit 1114 may efficiently pass through the catalyst 1126 for catalytic process.

Modifications, additions, or omissions may be made to the integrated reformer 1100 without departing from the scope of the present disclosure. For example, the coolant in the cooling unit 1114 may be used for cooling the mixture of the first gas stream and/or the second gas stream and steam from the heat utilization unit used for the steam reforming process. The coolant, after cooling the mixture of the first gas stream and/or the second stream, may be re-used by the cooling unit 1114 after condensing.

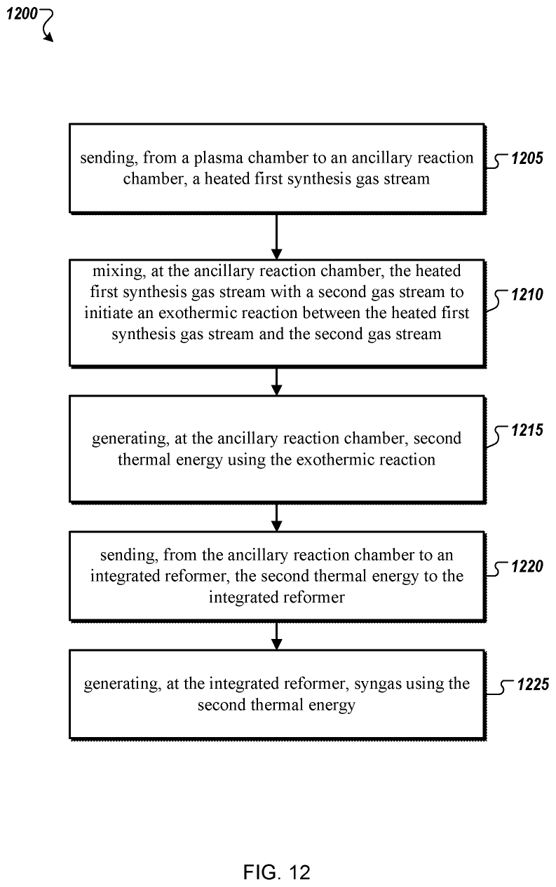

FIG. 12 illustrates a flowchart for an example method 1200 for plasma carbon conversion. The method 1200 may be performed by any component, including one or more of the plasma chamber, the ancillary reaction chamber, or the integrated reformer, or any other component, or subcomponent. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Although illustrated as discrete blocks, various blocks may be divided into additional blocks, combined into fewer blocks, or eliminated, depending on the selected implementation.

The method 1200, at operation 1205, includes sending, from a plasma chamber to an ancillary reaction chamber, a heated first synthesis gas stream. At operation 1210, the method includes mixing, at the ancillary reaction chamber, the heated first synthesis gas stream with a second gas stream to initiate an exothermic reaction between the heated first synthesis gas stream and the second gas stream (e.g., using the first thermal energy from the heated first synthesis gas stream). At operation 1215, the method includes generating, at the ancillary reaction chamber, second thermal energy using the exothermic reaction. At operation 1220, the method sending, from the ancillary reaction chamber to an integrated reformer, the second thermal energy to the integrated reformer. At operation 1225, the method includes generating, at the integrated reformer, syngas using the second thermal energy. One or more of the second thermal energy or the syngas may be generated without an external heat input. The method may include sending, to the integrated reformer, a third gas stream to generate the syngas.

The method 1200 may further include one or more of: (i) performing, at the plasma chamber, one or more of a partial oxidation reaction, a dry methane reforming reaction, a steam methane reforming reaction, or a hydrocarbon cracking reaction; or (ii) performing, at the ancillary reaction chamber, one or more of a partial oxidation reaction, a dry methane reforming reaction, or a steam methane reforming reaction; or (iii) performing, at the integrated reformer, one or more of a steam methane reforming reaction, a dry methane reforming reaction, a water gas shift reaction, a catalytic reaction, or a non-catalytic reaction.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A system comprising:
a plasma chamber configured to:
receive a first gas stream from a plasma chamber inlet;
apply heat to the first gas stream to form a heated first synthesis gas stream; and
output the heated first synthesis gas stream to an ancillary reaction chamber;
the ancillary reaction chamber configured to:
receive the heated first synthesis gas stream from the plasma chamber;
receive a second gas stream from an ancillary reaction chamber inlet; and
output a heated second synthesis gas stream to an integrated reformer, wherein the heated second synthesis gas stream comprises a reaction product of the heated first synthesis gas stream and the second gas stream; and
the integrated reformer configured to:
receive the heated second synthesis gas stream from a first integrated reformer inlet;
receive a third gas stream from a second integrated reformer inlet; and
output syngas from the integrated reformer.

2. The system of claim 1, wherein the plasma chamber is further configured to use an exothermic reaction to apply heat to the first gas stream.

3. The system of claim 1, wherein the plasma chamber is further configured to use heat to perform an endothermic reaction for the first gas stream.

4. The system of claim 1, wherein the plasma chamber is configured to perform one or more of a partial oxidation reaction, a dry methane reforming reaction, a steam methane reforming reaction, or a hydrocarbon cracking reaction.

5. The system of claim 1, wherein the ancillary reaction chamber is further configured to use heat from the heated first synthesis gas stream to initiate an exothermic reaction to generate the heated second synthesis gas stream.

6. The system of claim 1, wherein the ancillary reaction chamber is further configured to perform one or more of a partial oxidation reaction, a dry methane reforming reaction, or a steam methane reforming reaction.

7. The system of claim 1, wherein the integrated reformer is further configured to use heat from the heated second synthesis gas stream to perform an endothermic reaction to generate the syngas.

8. The system of claim 1, wherein the integrated reformer is further configured to perform one or more of a steam methane reforming reaction, a dry methane reforming reaction, a water gas shift reaction, a catalytic reaction, or a non-catalytic reaction.

9. The system of claim 1, wherein the ancillary reaction chamber is configured to receive one or more additional heated first synthesis gas streams from one or more additional plasma chambers.

10. The system of claim 1, wherein integrated reformer is configured to receive one or more additional heated second synthesis gas streams from one or more additional ancillary reaction chambers.

11. The system of claim 10, wherein the one or more additional heated second synthesis gas streams are received at one or more additional integrated reformer inlets.

12. A device comprising:
a plasma chamber in fluid communication with an ancillary reaction chamber;
an integrated reformer in fluid communication with the ancillary reaction chamber,
wherein the ancillary reaction chamber is configured to use heat from a heated first synthesis gas stream received from the plasma chamber to initiate an exothermic reaction with a second gas stream to output a heated second synthesis gas stream to the integrated reformer.

13. The device of claim 12, wherein the ancillary reaction chamber is further configured to perform one or more of a partial oxidation reaction, a dry methane reforming reaction, or a steam methane reforming reaction.

14. The device of claim 12, wherein the integrated reformer is further configured to use heat from the heated second synthesis gas stream to perform an endothermic reaction to generate syngas.

15. The device of claim 12, wherein the ancillary reaction chamber is further configured to receive one or more additional heated first synthesis gas streams from one or more additional plasma chambers.

16. The device of claim 12, wherein the integrated reformer is further configured to receive one or more additional heated second synthesis gas streams from one or more additional ancillary reaction chambers.

17. A method for plasma carbon conversion, comprising:
sending, from a plasma chamber to an ancillary reaction chamber, a heated first synthesis gas stream;
mixing, at the ancillary reaction chamber, the heated first synthesis gas stream with a second gas stream to initiate an exothermic reaction between the heated first synthesis gas stream and the second gas stream; and
generating, at the ancillary reaction chamber, second thermal energy using the exothermic reaction;
sending, from the ancillary reaction chamber to an integrated reformer, the second thermal energy to the integrated reformer; and
generating, at the integrated reformer, syngas using the second thermal energy.

18. The method of claim 17, wherein one or more of:
the second thermal energy is generated without an external heat input, or
the syngas is generated without an external heat input.

19. The method of claim 17, further comprising:
sending, to the integrated reformer, a third gas stream to generate the syngas.

20. The method of claim 17, further comprising one or more of:
performing, at the plasma chamber, one or more of a partial oxidation reaction, a dry methane reforming reaction, a steam methane reforming reaction, or a hydrocarbon cracking reaction; or
performing, at the ancillary reaction chamber, one or more of a partial oxidation reaction, a dry methane reforming reaction, or a steam methane reforming reaction; or
performing, at the integrated reformer, one or more of a steam methane reforming reaction, a dry methane reforming reaction, a water gas shift reaction, a catalytic reaction, or a non-catalytic reaction.
